(19) United States
(12) Patent Application Publication
(10) Pub. No.: US 2013/0318207 A1
(43) Pub. Date: Nov. 28, 2013

(54) SYSTEMS AND METHODS FOR MANAGING MOBILE APP DATA

(71) Applicant: James Eric Dotter, Boulder, CO (US)

(72) Inventor: James Eric Dotter, Boulder, CO (US)

(21) Appl. No.: 13/768,978

(22) Filed: Feb. 15, 2013

Related U.S. Application Data
(60) Provisional application No. 61/599,292, filed on Feb. 15, 2012.

(51) Int. Cl. H04L 29/08

(52) U.S. Cl. CPC H04L 29/08117
USPC 709/219

(57) ABSTRACT

A mobile device is described. The mobile device has a communication device, a display, an input device, a processor, and a non-transitory computer readable medium. The non-transitory computer readable medium stores an operating system defining a local file system on the non-transitory computer readable medium. The non-transitory computer readable medium also stores an app having an app layer, that upon execution by the processor, causes the processor to visually depict information prompting a user to identify a data management system configured to manage data for the app, receive an identification of a data management system via the input device, and establish communication between the app and an identified data management system via the communication device.

### INCORPORATION BY REFERENCE

The present patent application hereby incorporates by reference the entire provisional patent application identified by U.S. Ser. No. 61/599,292, filed on Feb. 15, 2012.

### FIELD OF THE DISCLOSURE

The present invention relates to a system for providing life-cycle data management, including but not limited to backup/restore, sync, and data sharing and data publishing services for apps running on mobile devices, and more specifically, to a system organized upon a changeable topology, such that the system can be scaled according to changes in traffic volume and data volume without disruption of the services, and such that highly efficient channels of data transfer are maintained throughout such topology changes.

The present invention also relates to a second system that connects and coordinates multiple implementations of the first system, such that global data sharing services are provided across these multiple first systems, and more specifically, such that a given implementation of the first system can be maintained independently and privately by an enterprise, while still participating in global data sharing and publishing when desired by said enterprise.

The present invention also relates to methods by which third-party mobile app developers can embed logic into their mobile apps such that the apps then operate as active components of the above mentioned systems without the ongoing involvement of the app developer, thus shielding the user or the user's enterprise from security leaks that might arise from the third-party developer's failure to apply adequate security measures in the management of the data. And more, that this can occur without the involvement of the operating systems or platforms on which the mobile devices are built, and without the involvement of the mobile device manufacturer or provider.

### BACKGROUND

The present application uses the term “mobile device,” by which is meant a telephony device or tablet-style computing device onto which can be installed an “app” (application, or software program). The term “third-party developer” refers to an app developer who creates and distributes apps for mobile devices and who is not the user, nor the platform provider, nor the device manufacturer. When an app on a mobile device is operated, it can generate or obtain data, and that data is termed “mobile data” or “app data.”

The challenge of managing mobile data, as viewed in the present application, is a relatively new problem in the computer industry. It began when users could buy apps from third-party developers to install on their phones. This was a turning point in the history of data: for the first time, a third-party app developer could sell an app to a customer, who would install and run it on their mobile device, and in the course of using that app, the customer could generate unique data that he or she would like to keep for a long time, and share with others. These devices are typically organized differently from laptop computers, and often they do not give the user full access to the device's local file system in order to make a personal backup. The user thus requires a new system for data management.

### Data Lifetime and Device Lifetime

Mobile devices are easily lost, stolen, or broken. For this reason, and because new models become available, users frequently replace or upgrade their mobile device. When the device is replaced, the user can reinstall the apps that he or she had purchased, but often the unique data that had been generated during the use of that app is lost.

The typical third-party app does not incorporate data management that extends beyond the device itself. This is due to the significant development that would be required to manage that data on servers, and to restore the data to a replacement device. No system exists that developers can link into their product to accomplish this. Some manufacturers offer a backup function for app data, but data restoration is only offered for replacement devices operating on the same platform or operating system. This method for backing up app data in general, as provided by the device manufacturer, is not a complete or satisfactory solution, because it prevents the user from switching to a different platform without data loss.

### Application-Generated Data

Agrawal (U.S. Pat. No. 7,849,135 B2) describes a system wherein data is created by content providers, and demonstrates a method by which mobile app user can send links or references to such generally available data to another app user. The current art, in contrast, is a system by which app users who generate data themselves, by means such as typing, carrying the device as they move from place to place, or wielding the device and making motions, to name a few examples, can share the resulting generated data with other, recipient users.

### Data Sharing

Communication is a core function of mobile devices, and except for normal phone calls, communication can be implemented using a system for data sharing. We send text and photos to one another, we share links to interesting Objects, and we exchange work-in-progress with friends and co-workers; these are all data sharing situations involving app-generated data. For each app developer to provide a robust system of data sharing would require an unrealistic development effort. This is especially true given a data network that is sometimes unavailable, mobile devices that are subject to loss or theft, and users who choose from an array of mobile platforms. Many useful apps could be created based on data sharing, if a system existed that developers could link into their apps to provide the data sharing framework. Such a framework needs to provide mechanisms and controls to respect the inherent rights of the mobile device users. These rights include long-term access to the data, privacy against unwanted access by others, the ability to set rules about how a recipient may use shared data, and other similar concerns.

### Files Vs Data Objects and Datasets

Tominaga (U.S. Pat. No. 7,773,977 B2) describes a system of data sharing based on files and file servers. Systems so designed are ideal for file-based applications, such as file sharing between PCs and Electronic Conference Terminals, as that art describes. In contrast, the presently described concepts describe a system the design of which flows from the communication and data sharing needs of the users of mobile device apps. The resulting design is based on individual or discrete Objects of data (herein called data objects) which are suitable for sharing to other app users. The method of representing these data objects also reflects the relationships between them, and the properties of authorship, ownership, and access rights of various parties. Uniquely, the presently described concepts also simultaneously represents collections of said data objects along with ancillary data, (the whole herein called a Dataset) which form the sum total of data needed by an app on a device, thus providing for backup/restore and sync operations.

Independence from Platform Provider

Today, no method is available to app developers to facilitate cross-mobile-platform data management. Mobile devices are offered by several manufacturers, based on different platforms and operating systems. A developer can maximize app sales by offering the same app on multiple platforms. Further, for developers creating apps that involve communication and data sharing, it is essential to be able to extend the sharing framework across multiple platforms, so that friends and co-workers on different platforms can share data and communicate. Moreover, when users upgrade their mobile devices, they should have the option to switch to a different mobile device platform. At present, even though the same app may be available on several platforms, it is usually not possible for a user to switch platforms, install the same app on their new device on the different platform, and recover the same unique data he or she had generated on the prior device. To the app developer, the development cost of creating this feature would be very high, because the infrastructure would have to be created anew for each app, and by each developer, and because a method of implementing a universal or mobile-platform-independent data set has not been made available by the platform providers.

The features of backup and restore, sync with other devices owned by a user, and the sharing of data Objects with other mobile users, all share a common foundation: data created and residing on a mobile device, and under the control of a mobile app, must be mirrored outside of that device. The providers of the platforms on which these devices operate do provide a means of mirroring data on servers. In these scenarios, the device's operating system manages replication of the data related to each app, for possible restoration later. This relieves the app developer of the difficult task of implementing a data mirroring scheme within the app. Craswell, et al (U.S. Pat. No. 7,792,799) provides a typical example of a data management scheme whose function is built into the operating system.

The price for this convenience, however, is that the platform provider, guided by obvious competitive objectives and desiring to keep the customer, only offers restoration and syncing to devices on the same platform. Thus, while the user is free to switch to a different platform in the future, he or she is not able to retain previous data generated on the prior platform. A solution that offers assurance of the ability to switch platforms and still restore old data, or to own devices on different platforms and to sync between them, must remove the platform provider from a controlling position with respect to these data management functions.

Similarly, the device's operating system cannot be relied upon to grant permission for these data management functions to be performed. Yu et al (U.S. Pat. No. 7,707,190 B2) shows a method for backup and restore of data on a device that requires a backup application to be installed on the device, separate from the apps that run on the device. Given the current architectures in smart phones, where each app has a “sandboxed” data storage area that is not accessible to other applications, Yu's design only functions if the backup/restore application is itself immune from this restriction, which can only occur if that application is provided by the provider of the platform or operating system, or operates with special privileges granted by the platform provider. Backup/restore solutions that are linked to the platform provider lack the independence required to be able to offer cross-platform functionality without regard for the policies, business needs or strategies of a platform provider. Due to the embedding of the backup/restore, sync, and data sharing logic into the app itself, the present invention does not have that restriction.

The present art provides a system by which the app itself, in communication with a collection of servers of a unique structure, contains the logic of backup, sync, and share. And it also provides a method by which app developers can easily include this specialized logic into their apps to make them function as components of this system. In this system, the device's operating system is not involved in the data management, other than providing basic local storage and connectivity services. Since the platform and operating system are not involved, the system can be designed to work across multiple platforms and operating systems, independent of constraints imposed by platform providers.

### Platform-Independent Data Synchronization

With the release of tablet-sized smart mobile devices, it has become more common for an individual to own multiple mobile devices. This person may want to use the same apps on them, and keep the same data, synchronized, on all of his or her devices, to avoid having to remember on which device an important Object is stored. Further, this individual may choose one platform for their smartphone, and a different one for their tablet. This is another case where a platform-independent data management system needs to be made available to app developers for inclusion in their apps.

### Intermittent Connectivity and Data Sharing

Due to relatively slower data transfer rates across the wireless data network, and the occasional unavailability of that network, users desire to keep data locally on the mobile device in order to have access to it quickly and at all times. An example is to be able to continue working while on an airplane, while the network is unavailable, and to have any newly generated data be shared and backed up automatically once the plane lands and the device's network access is restored. Likewise, once network access is restored, any new data or changes that have been shared to this individual from others should be brought to, and stored in, the appropriate app on the mobile device. This requires a system that keeps track of what Objects of data on the device have been modified and have not yet been sent off for backup and sharing, and also keeps track of any new data that has been shared to this user through the sharing framework while the device was not connected to a network. Again, a system that provides this important feature, and a method for developers to link such a system into their app, is currently not available in a cross-platform approach.

### Scalability

Mutter (U.S. Pat. No. 6,671,757 B1) and many other prior art examples show a server-based system providing backup and sharing, but none address the need for scalability of such a system as usage increases. In contrast to these, the present art incorporates a unique design involving multiple servers, each with specialized logic and tasks, and providing for a massively scalable solution without disruption of service to users.

Independence from Existing Modes of Data Sharing

Much prior art (Machani US 2011/0154456 A1, etc.) describes systems that make use of existing modes of data sharing, including SMS, MMS, and email systems. These systems necessarily require the user to be involved in somehow moving that data from an app designed for that data, into some other app such as an email or SMS app, by using copy/paste or similar functions. And the recipient must also manually transfer received data from the email or SMS app into the appropriate app for viewing.

In contrast, the presently described concepts describe a system in which users share data in the context of the same or a related app, on their separate devices. That is, a user working in an app decides to share data with another user and indicates so without leaving the app, ideally by simply touching a “share” button. On the receiving end, the data is sent to the recipient directly into the app where it can be permanently stored, and it is presented in a meaningful context, with formatting and other information included in the shared set, and with ancillary information about who shared it, who else it was shared with, and the terms and conditions of the share.

Systems that make use of SMS, MMS, or email systems already supported by the mobile device cannot match the immediacy and user-simplicity made possible by the present art, due to their lack of contextual information: SMS messages can only be displayed in an SMS app, and cannot be automatically routed to the appropriate app. The same limitation makes MMS and email systems inferior to the present art for the purposes stated earlier.

### Need for a New Architecture

At present, the dominant system for data management is known as the “client-server” architecture. It is characterized by a server that provides data as requested by a client, such as a browser program running on a personal computer. The client-server model is very powerful and useful in any system where data can be kept by a single entity (a server) and requested by any number of other entities (the clients) whenever needed, such as when serving up web pages or keeping track of airline reservations.

Client-server architecture predates the advent of mobile devices running apps, and was not designed for the special problems involved in managing data from mobile devices. Indeed, no existing computer system or architecture has been developed to address this unique problem set in a systematic platform-independent way. The requirements and challenges unique to mobile apps indicate a need for a new architecture-one that has been designed from the beginning to solve these problems.

### An Architecture for Robust Apps

The systems and methods herein combine to describe a new architecture that, while making use of client-server architecture where appropriate, is uniquely capable of handling the many new data management requirements of mobile apps, in a cross-platform, data-sharing environment.

Currently, the challenge to app developers who wish to develop robust, well-behaved apps (with respect to data management) is daunting. The infrastructure development needed to perform even a simple backup and data restore to a replacement device, or synchronization of data on the user's other devices, is typically beyond the scope of the planned app development. More sophisticated apps that involve data sharing with collaborators, maintaining at the same time the privacy, control, and data security desired, are far beyond the capabilities of many app developers and far beyond the development budget if he or she must create all of this infrastructure from scratch. And doing all of this in a cross-platform manner is even more cost-prohibitive.

The presently described concepts describe systems that create a sophisticated data management system and which become, in effect, a new architecture for app data. Then it describes methods that allow app developers to easily create apps that are configured to operate as components of the system, without requiring that the app developer provide the actual system itself to customers. In this way, developers can offer apps to their customers with powerful sharing and data management features, within a reasonable development budget.

### An Architecture for Data Independence

In the current environment, when data management beyond the device is required, lacking any better alternative the app developer must provide the requisite server-side support tightly integrated with the app, and thus must remain involved in the data management operations for all users of the app, for the duration of their use.

By leveraging the systems and methods herein, it will be possible for developers to offer apps to customers without the developer being involved in the long term data management for those apps. This provides customers with options for increased security and control over their mobile data. Enterprise customers, for example, can host their own data management system, and thus can securely use third party mobile apps for tasks involving sensitive and proprietary data and communications.

### DESCRIPTION OF DRAWINGS

FIG. 1 shows an exemplary second system showing a ModixCentral 1, a first system (Modix) 4 showing a TopServer 6 and AppServers 8 and 9, another first system (Modix) 5 containing a TopServer 7 and AppServers 10 and 11 with Mobile Devices 12, 13, 14 and 15, each with a subset of installed and Registered Apps 16 through 19.

FIG. 2 shows an exemplary division of logic within a Registered App 16 on a Mobile Device 12, with logic divided into an App Layer 30 and a Modix Layer 28 along with an exemplary second system component ModixCentral 1 and first system (Modix) 4, with TopServer 6 and AppServer 8, these shown to be in communication with the Modix Layer 28 via lines 22, 26 and 27.

FIG. 3 shows an exemplary algorithm for registering an App 16 on a Device 12 with a ModixCentral 1 of a second system (Global Modix System) 2, and then with a TopServer 6 of a first system (Modix) 4, resulting in an assignment of an AppServer 8 for the newly registered App 16 and the commencement of data management operations.

FIG. 4 shows an exemplary scheme for data management showing Mobile Device 14 with installed and registered Apps 17 and 18, each with sandboxed datasets 47 and 48 respectively, with dataset 48 shown in detail having one object therein, Object 101, also shown in greater detail as being on AppServer 10 of a first system (Modix) 5, and the storage therein of App Ancillary Data 247 and 248 for registered Apps 17 and 18 respectively, on Device 14.

FIG. 5A shows an exemplary object tree of Object 101 prior to addition of child objects related to the creation of the completed newsletter by collaborators.

FIG. 5B shows an exemplary object tree of Object 101 after collaborative work by various contributors has added child objects to the tree.

FIG. 6A shows an exemplary first system (Modix) 200 with TopServer 201 and AppServer 202, shown prior to load balancing operation.

FIG. 6B shows an exemplary load balancing operation performed on Modix 200 from FIG. 6A.

FIG. 6C shows an exemplary first system (Modix) 200 shown after the load balancing operation of 6b, showing a TopServer 201, an AppServer 202 and an AppServer 203, with communication 25 between the AppServers.

FIG. 7 shows an exemplary algorithm by which an App 400 on Device 12 may obtain a new AppServer 203 after a load balancing operation such as depicted in FIG. 6B.

FIG. 8 shows an exemplary depiction of the state of data representation for two Apps, App 18 on Device 14, and App 18 on Device 15 respectively, with sandboxed dataset 48 on Device 14 is shown in expanded view to include object 101, and AppServer 10 containing permanent storage 32 which holds object 101 for App 18 Device 14.

FIG. 9 shows an exemplary depiction of the modified state of data representation as in FIG. 8, but after a share operation.

FIG. 10 shows an exemplary algorithm by which an Object 110 is shared from App 18 Device 12 to App 18 Device 14.

FIG. 11 shows an exemplary method by which a Data Object 110 is converted from Modix Common Format to a data format native to the local platform and operating system of Device 14, and used in App 18 on Device 14.

FIG. 12A shows an exemplary Dataset object tree for App 18 on Device 12, showing object 101 as the child of object 61 in the tree.

FIG. 12B shows an exemplary Dataset object tree for App 52 on Device 49, showing object 62 as an element of the Dataset due to it having been shared by App 18 on Device 12.

FIG. 12C shows an exemplary algorithm by which Object 101 from FIG. 12A is relocated in the tree, and made to be a child of Object 62.

FIG. 12D shows an exemplary Dataset object tree showing the result of the operation described in FIG. 12B, in which Object 101 was made a child of Object 62. At this point, Object 101 and all of its children are now under Object 62.

FIG. 12E shows an exemplary Dataset object tree showing the effect on App 52 of Device 49 after the algorithm in FIG. 12B is executed, with the sub-tree headed by Object 101 now appearing in this Dataset as a result of Object 62 already having been shared to App 52 Device 49, and Object 101 newly assigned as a child of Object 62.

FIG. 13A shows an exemplary Dataset object tree for App 1044 on Device 12 depicting a moment at which Kate has created a new communications thread, headed by Object 1076, with child Object 1077, and has created a share list for object 1076 and children.

FIG. 13B shows an exemplary Dataset object tree for App 1044 on Device 156 depicting that Object 1076 as shared by Kate is now an element in this Dataset.

FIGS. 14A, B, and C show exemplary Dataset object trees for App 1044 Device 12, App 1044 Device 156, and App 1044 Device 3556 respectively, with the replication of the object tree headed by Object 1076 into the Datasets for each App as various members add objects to that object tree is depicted.

FIG. 15 shows an exemplary configuration showing the redundant occurrences of Data Object 125 when it is shared between Apps on Devices supported by different Modixes.

FIG. 16 shows an exemplary configuration showing the reduction in redundancy relative to FIG. 15, when a GMS SharedServer 77 is employed to store Data Object 125 which is mutually needed by multiple Modixes 4 and 5.

FIG. 17 shows an exemplary configuration showing a GMS Publishing System wherein PubServer 78 is employed to store Published Data Object 126 which is mutually needed by multiple Modixes 4 and 5, and PubServer 78 also maintains records about the Published Object 126 in Ancillary Modix Publish Data 47 and in GMS Pub Link Info 48.

FIG. 18 shows a diagrammatic representation of an embodiment of a mobile device in accordance with the present disclosure.

FIG. 19 shows a diagrammatic representation of an embodiment of the first system of FIG. 2.

FIG. 20 shows a diagrammatic representation of an embodiment of the second system of FIG. 1.

### SUMMARY

The presently described concepts are comprised of a first system (called herein a “Modix”) that provides a data management structure for an entity such as a company, organization, family or individual, for data related to apps installed on mobile devices to be operated by members of that entity. This first system is characterized as having a TopServer (or Topology Server) to manage the changeable structure of the system, and a plurality of AppServers, designed to communicate directly with the plurality of installed and registered apps (or “Apps”) under this system's management, each App being assigned a specific AppServer. The data service provided by the first system is characterized as offering backup and sync services, as well as data sharing services between members of the entity.

The presently described concepts are further comprised of a second system (called herein the “Global Modix System”) characterized by having a ModixCentral server that coordinates a plurality of first systems (Modixes), and by the fitting of Modix components with additional specialized logic enabling each Modix and App to operate as a component of this second system, and thereby extending data sharing and data publishing services to Apps served by different first systems, that is, data sharing between Modixes.

The presently described concepts also describe methods by which app developers can incorporate special logic into their apps thus preparing them to behave as active components of these first and second systems, in particular these methods provide for 1) translation between a common data format used by the first and second systems and data formats that are native to multiple mobile platforms, 2) a hybrid of device-local and network-based storage of app data.

A system is described for managing mobile app data, which allows users of mobile devices to save data securely, recover data to the same or a replacement device, sync data to other mobile devices, and to share data with other mobile device users. These benefits are provided with respect to app data whether it is generated originally on the mobile device, shared by another user, or received by any other means. These benefits are provided even when the mobile devices involved are of several types, running different operating systems and based on different platforms. The unique design of the system provides for massive scalability without disruption of service to the users.

A second system is described for interconnecting a plurality of the first systems, such that data sharing is provided across these systems. The systems allow enterprises to more readily adopt the use of apps created by third-party developers, by providing secure life-cycle data management for the installed apps, separating the app developer, mobile platform provider, or mobile device provider from involvement in the ongoing data management.

Methods are described to facilitate the creation of mobile apps which are configured to participate in the described data management systems. These methods provide a means of developing similarly designed apps for multiple mobile platforms, such that the apps can participate in data sharing and recovery operations across different and otherwise incompatible mobile platforms. The methods provide this without the involvement of the device's operating system or platform, thus allowing the described systems and methods to be compatible with multiple mobile platforms without the approval of the platform provider(s).

### DETAILED DESCRIPTION

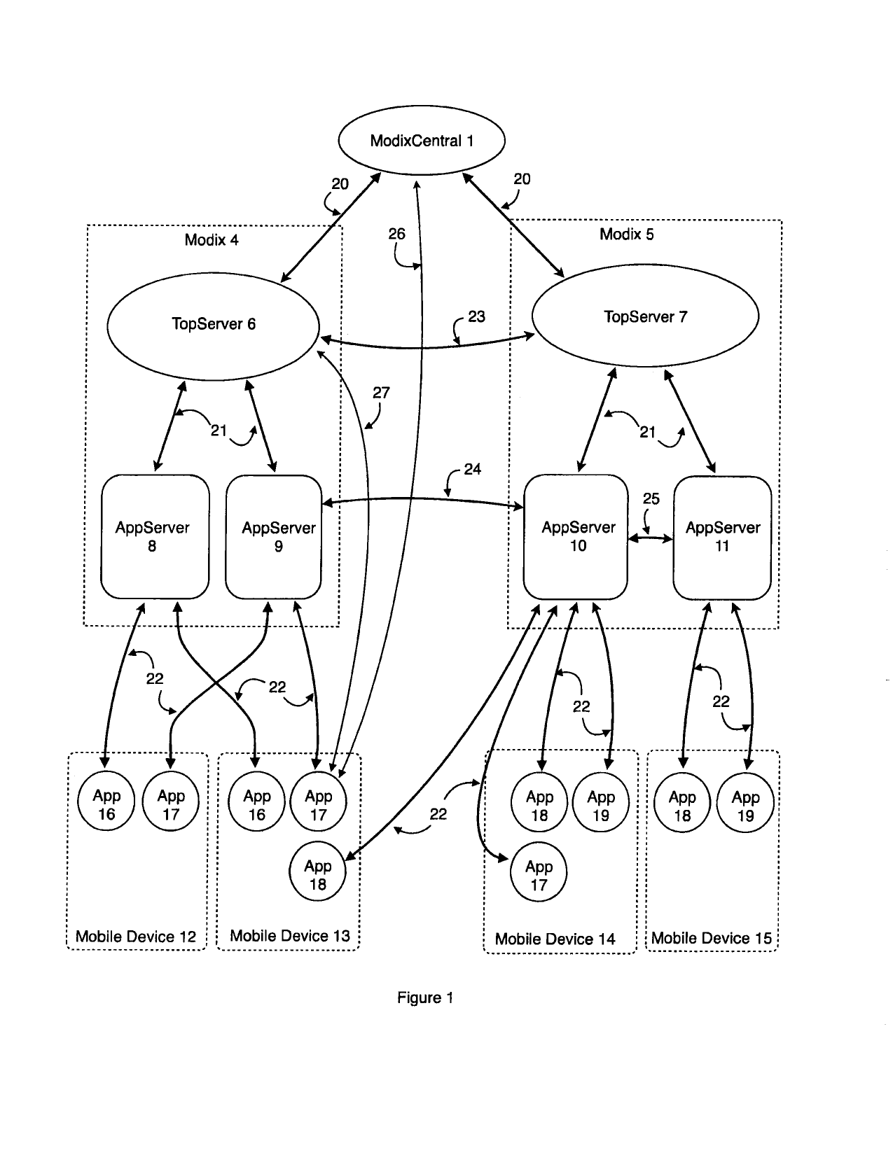

FIG. 1 presents an exemplary model of the presently described concepts, showing a second system with ModixCentral 1 coordinating a first system (Modix) 4 with TopServer 6 and AppServers 8 and 9, with another first system (Modix) 5, containing TopServer 7 and AppServers 10 and 11. Modix 4 directly manages the data for specially prepared and installed Apps 16 and 17 on Mobile Device 12 and for Apps 16 and 17 on Device 13. Modix 5, through AppServer 10, directly manages the data for Apps 17, 18, and 19 on Device 14, and also App 18 on Device 13. Also, via AppServer 11, Modix 5 manages Apps 18 and 19 on Device 15. FIG. 1 shows a plurality of AppServer servers 8 and 9, at least one TopServer (TopologyServer) 6 and 7, a plurality of Apps 16, 17, 18, and 19 running on SmartDevices 12-15, algorithmic methods embedded in the AppServers 8-11, the ModixCentral (TopologyManager) 1, and Apps 16, 17, 18, and 19, and data representation. The plurality of AppServers 8 and 9 each contain specialized logic, connectivity, permanent storage, and optionally a relational database management system (RDBMS), and designed to interface with specialized app or app(s) running on SmartDevices 12-15 and to replicate data generated by said Apps 16, 17, 18, and 19 or shared to said Apps 16, 17, 18, and 19. The TopologyServers 6 and 7 contain specialized logic, connectivity, permanent storage, and optionally an RDMBS, and are designed to interface with all of the AppServers 8-11, and with the Apps 16, 17, 18, and 19 running on SmartDevices 12-15. The specialized logic is designed to modify the system's (Modix 4 or 5) topology by adding or removing AppServers 8-11 or by rearranging which Apps 16-19 are served by which AppServers 8-11, as required by data traffic and data storage requirements resulting from the usage of said Apps 16-19. The specialized logic may also be designed to assign an AppServer 8-11 to an App 16-19 when said App 16-19 registers and requests data management service. The plurality of Apps 16-19 running on SmartDevices 12-15 and include a set of specialized logic unique to this system but integrated with its app-specific logic. The specialized logic may be designed to interface with the TopologyManager 1 to register and to obtain connection information requisite for establishing connections with an AppServer 8-11 designated for the App 16-19 by said TopologyManager 1. The specialized logic may also be designed to interface with said designated AppServer 8-11 to accomplish the said life-cycle data management for its data as well as gateway communications to Apps 16-19 on other SmartDevices 12-15 managed by the system (Modix 4 or 5). The data representation may be in a form such that the data serves both as a complete backup for an App 16-19 on a device 12-15, and as a collection of related data objects which may be shared on a per-object basis, which features a collection of uniquely identified data objects associated in a tree structure, and ancillary data related to the use of said data tree and data objects in the app for which the data tree is relevant.

Optionally, additional servers as needed may be added. The additional servers contain specialized logic, connectivity, permanent storage, and RDBMS, and which specialized logic is designed to extend the topology of the system (Modix 4 or 5) and to enhance the management capabilities of the system (Modix 4 or 5). The algorithmic methods are embedded in the AppServers 8-11, the TopologyManager 1, and the Apps 16-19 such that additional AppServers 8-11 may be added to the system (Modix 4 or 5) while the system (Modix 4 or 5) continues to operate, and therefore define a system (Modix 4 or 5) that is massively scalable.

Managing a copy of data objects relative to the Apps 16-19 locally on a mobile device, such as devices 12-15, may include, synchronizing with a copy of said data objects external to the device, such as a copy located on the AppServers 8-11, in which the local and external versions are maintained to be identical as changes are made to one or the other.

A method is also described. The method converts data objects relative to an app on a device such that when stored external to the device said data objects are stored in a common format regardless of the mobile platform on which it was originated. When the data objects are used by an app said data objects are represented in a format that is native to the platform and operating system that the device and app are based upon. A method to register an app on a device with a system is also described. This method establishes said system as the provider of data management services to said app.

A method of sharing data objects between apps on devices is also described. In this example, a uniquely identified data object can be shared, and upon said sharing, the full branch of a data tree with said data object as the head is also shared such that said branch is replicated to recipients in its entirety.

A subset of the possible lines of communication between components of these systems are represented in FIG. 1 by double arrow lines, which will be explained in summary here and in greater detail later in this document. For now, note that communication in the second system flows between ModixCentral and the TopServers of active Modixes, represented by line 20. Communication within first systems (Modixes) flows between TopServers and AppServers as represented by line 21, and between AppServers as shown by line 25, which may for example facilitate intra-Modix data sharing between App 19 on Device 14 and App 19 on Device 15. All communication between a Modix and an installed and registered App occurs between the App and its AppServer as represented by line 22, except in rare cases to be discussed later.

In this FIG. 1, apps with the same number represent apps of the same or a related title. When installed on a specific device and registered with a Modix, each one becomes a unique component of these systems. Data sharing here is typified as between apps of the same title or a related title. So for example a user operating device 12 may share data in her App 16 with the user operating device 13, which data would be presented to that user via his App 16. In the presently described concepts, the term Data Sharing refers to sharing of data to the same or a related app title installed on a different device operated by a different user. Data Publishing on the other hand, also supported by these systems, is not constrained in this way. Data Publishing will be discussed later.

Also in FIG. 1, note that Device 13 has installed on it Apps 16 and 17 which are served by Modix 4, and also App 18 which is served by Modix 5, illustrating that the various Apps on a device may be served by different Modixes. This represents the possibility that a device may have for example some Apps for personal use served by a personal Modix, and other Apps for business use served by a company Modix.

Note also in FIG. 1 the double arrowed line 24 connecting AppServer 9 in Modix 4 with AppServer 10 in Modix 5. Once established, this channel of communication would facilitate rapid data sharing for example between App 17 on Device 13 and App 17 on Device 14, despite being served by different Modixes. This is an example of the second system extending data sharing service between multiple first systems.

Still in FIG. 1, lines 26 and 27 illustrate the communication involved in the initial registration of an installed App, which includes the App first asking ModixCentral for contact information of a specific Modix (exemplified by line 26), and then asking that Modix through its TopServer as exemplified by line 27 for a designated AppServer. In this FIG. 1, lines of communication used in the registration process are only shown for App 17 on Device 13, but the same process is executed by all Apps.

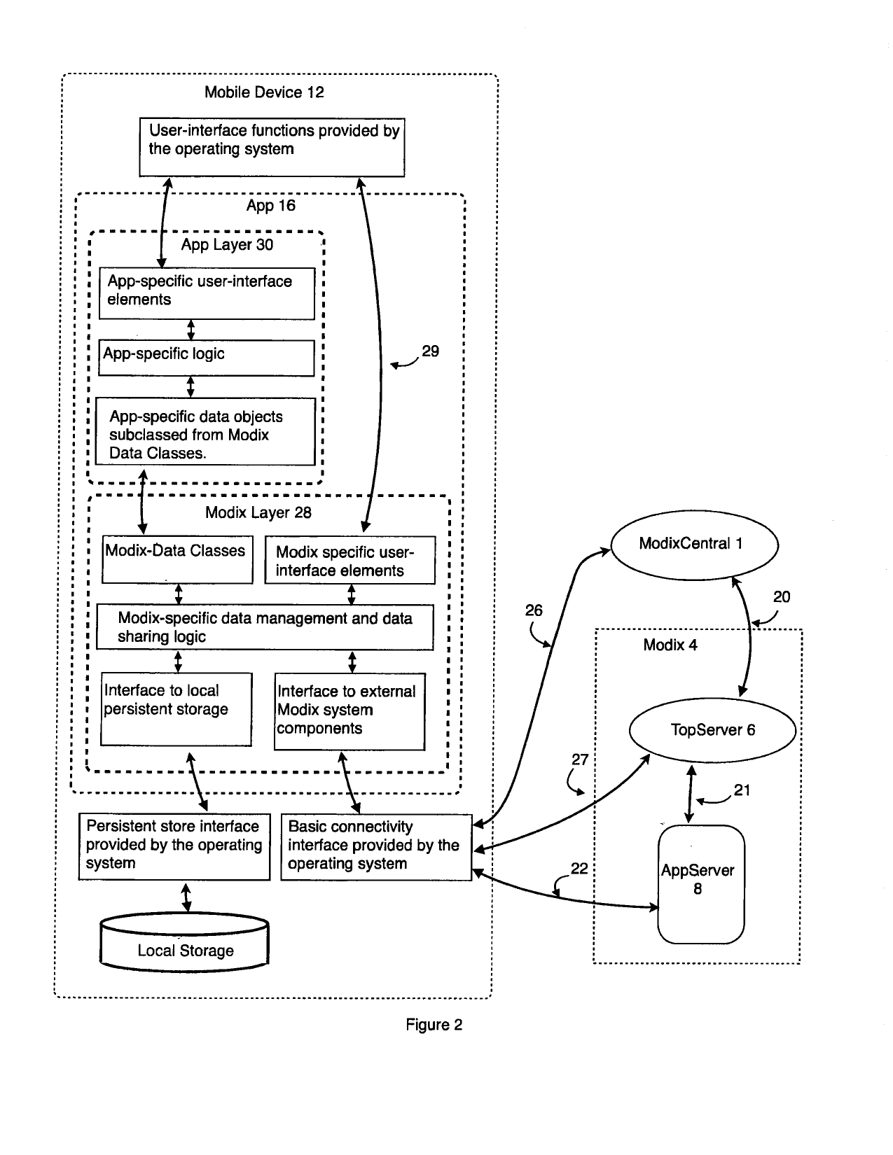

The presently described concepts further describe methods and procedures by which a collection of logic specific to an App's participation in these first and second systems can be encapsulated such as for example into a code library that, when properly integrated with the other App logic, makes the App act as an active component of these systems. This encapsulation is herein called the “Modix Layer” of the App. Said methods and procedures are illustrated in FIG. 2.

FIG. 2 shows a block diagram of an exemplary arrangement of modix-specific code modules comprising the Modix Layer 28. Modix Layer logic is generic; it is not specific to the workings of any individual app but rather contains logic to facilitate any and all apps to act as participants in the first and second systems. In FIG. 2, Modix Layer 28 is linked with app-specific code modules in the App Layer 30, which contain the specific logic that makes the app perform in some unique way. The combination of Modix Layer 28 with app-specific layer 30 comprises App 16 in a mobile device 12. FIG. 2 also shows elements provided by the operating system and the device itself, such as local persistent storage.

As illustrated in FIG. 2, required data management tasks are relegated to the Modix Layer 28. The app-specific logic of the App Layer 30 needs only to define and use data classes as subclasses of Modix data classes, as defined in the Modix Layer, in order to obtain the data management functions offered by these first and second systems.

Moreover, the operations of FIG. 2 occur without any special action, components, or functionality from the operating system or from the device, other than standard functionality provided to any app such as persistent local storage and basic network connectivity. Thus data management is provided without the knowledge or involvement of the platform provider or device provider. This is key to the ability of the presently described concepts to deliver on its promise of a data management system that is platform-independent.

FIG. 2 also shows that the Modix Layer 28 may itself present user interface (UI) elements to the user, through UI functions provided by the device operating system, shown as line 29. In this manner, the Modix Layer can take over the user interface to facilitate data sharing operations, obtaining the user's intent with respect to sharing of specific data objects, and immediately executing required communication with server elements of the systems such as for example with AppServer 8 via communication channel 22. Thus rapid data sharing is accomplished, and the app developer has not been required to develop this complex logic.

In an exemplary embodiment, the Modix Layer 28 may be comprised of specialized logic embedded into an App to be installed on a SmartDevice and operated thereon. The Modix layer 28 may be made resident on the device and accessible by the App, such that said App may function as a logical element of an extended data management system such as for example but not limited to the first system and the second system, described below, thereby providing data management services to said App. This specialized logic makes use of standard connectivity and local storage capabilities executed from within the app, as provided by the platform and operating system of the SmartDevice to execute the data management functions discussed above. Said functions are completed either immediately while the App is active, or immediately thereafter while the app is in a background state but still able to communicate with external servers such as its designated AppServer. The functions may also be completed at the first opportunity thereafter when the app is once again able to communicate with servers. Therefore the data management functions do not require the involvement of the operating system or platform, except insofar as ordinary connectivity and access to local storage is provided by the platform to any App, irrespective of the purpose or operation of that App.

The creation of a server-based system such as but not limited to the second system to provide support for said life-cycle data management may be established by an entity other than the app developer. The creation of the server-based system requires no involvement of the app developer other than to indicate to the specialized embedded logic that such data management is desired. The indication may be done by some means external to the app-specific logic, such as for example an included settings file, and by the use of or subclassing of data object classes provided by the embedded logic. The app developer may not be provided with any information of any aspect of said life-cycle data management, including but not limited to where the data is stored or how to access it. The app developer may also not be provided with any means of altering or deleting any of the data managed thereby, other than through the normal operations of the app as any app user could do.

In the Modix Layer 28, operations that implement the life-cycle data management are executed automatically during the running of the app, without the need for any action on the part of the app user, except that the app user may indicate sharing preferences for specific data objects or a collection of data objects. Life-cycle data management is provided for data objects, on a per-data-object basis. The data objects may be collected and organized into a data tree which, along with ancillary data, constitutes a full backup of the app. Sharing of specific data objects, based on user input, is managed by the embedded logic, with no involvement of the app developer other than to indicate a desire for certain data objects to be shareable by the use of or subclassing of data object classes provided by the embedded logic. The app developer may also provide a hook such as for example a button marked “share” at an appropriate location, the activation of which engages elements of the specialized embedded logic to take over and manage both the user interface elements, and the subsequent data management functions needed to implement sharing of the specified data object.

The specialized logic may be embedded into an app by the inclusion of a pre-compiled library of software, which is then linked together with the unique source code for the app. The specialized logic may also be embedded into an app by the inclusion of a set of source code which is then compiled along with the unique source code for the app. The specialized logic may also be embedded into an app by a combination of a pre-compiled library linked with the source code of the app and the inclusion of a set of source code compiled along with the source code for app. Further the specialized logic may be embedded by any other reasonable means of inclusion, including for example but not limited to the inclusion of a dynamic library, or the inclusion of uncompiled scripting-language source code.

Instead of embedding the specialized logic into an app, the specialized logic is made available to the app by installing a separate program, app, or logic set on the SmartDevice. The logic is thereby accessible to the app at runtime, and performs the requisite specialized tasks on behalf of the App, as if the logic were embedded in the App.

Persistent storage of data objects is provided, both logically and by participation in an external data management system including but not limited to the second system. In one embodiment, no further involvement of the app developer is required for the persistent storage of data, other than the subclassing of data object classes provided by the specialized logic when defining data object classes for use in the developer's app-specific logic.

The specialized graphical user interface elements are provided to the user for the purpose of determining the intended backup, restore, sync, and/or sharing of data objects. The specialized graphical user interface is provided with no further involvement of the app developer other than providing a means in the app-specific graphical user interface to access the specialized graphical user interface elements, in which specialized logic is provided for the persistent store of user-indicated intentions so received.

The presently described concepts further describe methods and procedures by which installed apps may become registered with a selected first system (Modix) of the user's choosing, may be approved by that Modix for inclusion in the system, and be assigned an AppServer within that Modix for ongoing direct support and communication. These methods provide for these steps to be hidden from the app developer by the placing this logic in the opaque and secure Modix Layer, thus creating a data management system that is secure even from the developers of the app. Users of these apps, such as enterprises for example, may thus gain assurance that these apps do not constitute a potential security breach for sensitive data.

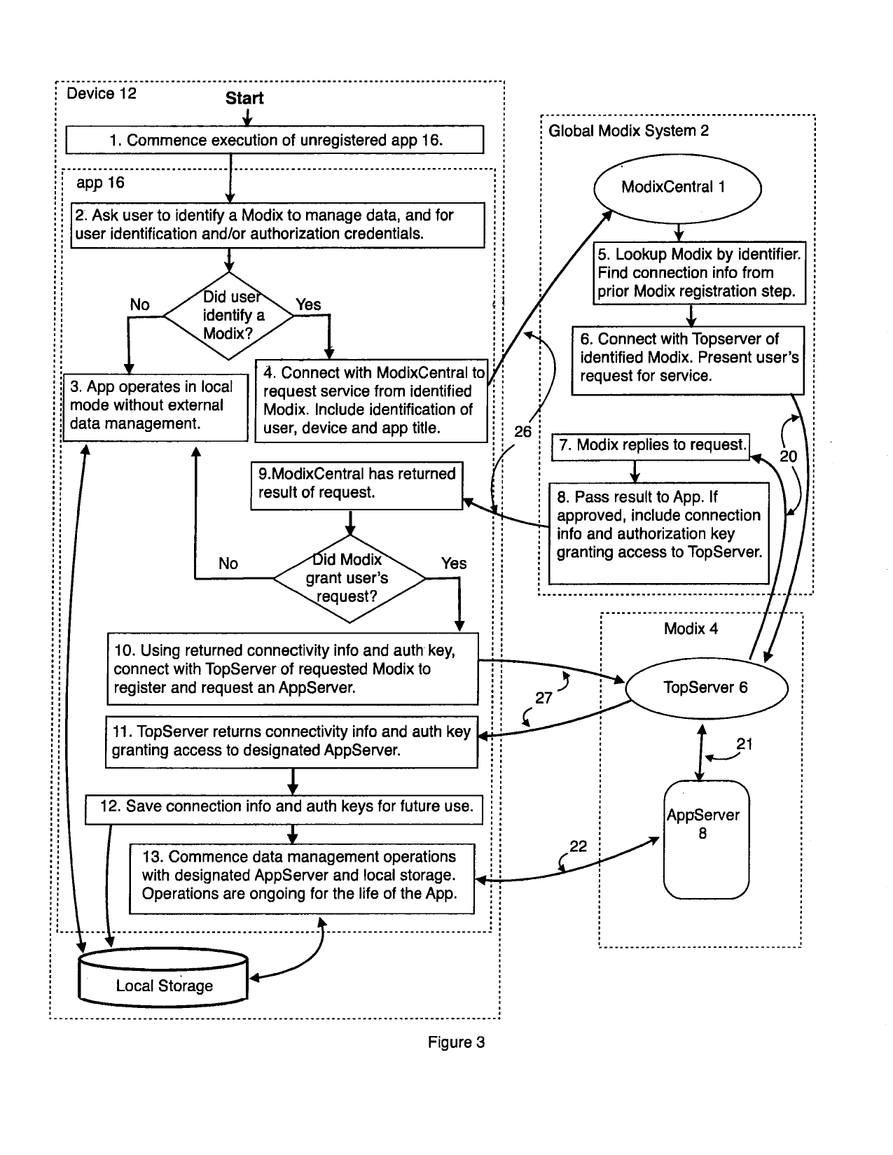

FIG. 3 shows an exemplary flow diagram depicting the operations involved in the registration of an app with a Modix, and the assignment of a designated AppServer. This logic is executed within an installed app 16, which has not yet been registered with any Modix. Furthermore, this logic is executed within the Modix Layer 28 of the app 16 as per FIG. 2, which is opaque to the app developer, rather than in app-specific logic. In step 2 of FIG. 3, the Modix Layer within app 16 takes control of the user interface and requests certain information of the user, including an identifier for the desired Modix, and optionally other credentials.

FIG. 3 illustrates that at the time of installation of the app on the device, only connectivity and authorization required for the app to reach ModixCentral (step 4) need be included, and this is built into the opaque Modix Layer. Only after the requested Modix approves the app, based on user identification, device identification and app title identification sent with the request, does ModixCentral share connectivity and authorization information with the app to enable it to reach the requested Modix, as shown in step 8. This sensitive information is only handled by the Modix Layer.

FIG. 3 further illustrates how the design of an exemplary embodiment of the system facilitates fast and efficient operation: communication with ModixCentral and with the TopServer of the Modix is only required during registration. Once registered, the App communicates directly only with its designated AppServer. The number of available AppServers and the traffic load on each can be managed to provide rapid response to the Apps in day to day operations.

### Description of the First System

The first system of the present art (called herein a “Modix”) is a system that provides secure life-cycle management of information generated by the use of apps on mobile devices (“mobile apps”) and especially provides a means by which information may be exchanged between users of mobile apps, if these apps are served by the same first system.

This constitutes a closed and self-contained system that may be installed on a server or servers hosted by some entity other than the app developer, and other than the platform provider or device provider, such as for example by an enterprise using multiple installed copies of the app for its company communication, or by a trusted service provider selected by the enterprise.

### Components of a Modix

A Modix is comprised of a plurality of components, including but not limited to computers, mobile devices, and apps running on the mobile devices, each component of which is fitted with logic, data storage, and connectivity as needed to perform a defined set of functions within the system.

A Modix is comprised of at least the following components:

A plurality of AppServers: An AppServer combines elements of logic, data storage, and connectivity residing on a server or servers configured for specific tasks centered around direct communication with apps running on mobile devices, and the immediate management of the associated data. An AppServer, once assigned to an app on a device, handles all of the normal data management operations for that app on that device.

TopServer (or Topology Server): A TopServer combines elements of logic, data storage, and connectivity residing on a server or servers configured for specific tasks related to managing and coordinating the plurality of AppServers in the system. The TopServer also communicates with an app on a device to assign an AppServer to that app.

A plurality of specially constructed Apps: These run on mobile devices and contain, in addition to app-specific logic, a collection of elements of logic, data storage, and connectivity common to all Apps that act as components of the system, which collection is described herein as an App's Modix Layer. The data for these Apps is the data that is managed by the system. Apps communicate with a TopServer and an AppServer as required.

Additional specialized servers may also be present in the system, as described in the detailed description later in this document. Such specialized servers provide additional oversight and management control for more complex Modixes.

The mobile Devices on which the Apps are installed are also components of the system, in that an App becomes a unique system element once it is installed on a Device and registered with the system. Uniqueness of an App is based on a specific app title being installed on a specific Device.

### Modix Data Classes, Data Objects and the Data Model

FIG. 2 showed an exemplary method of incorporating specialized logic described in The presently described concepts, the Modix Layer 28, with app-specific logic, the App Layer 30, to produce an app capable of participating in this system. Since this is a data management system, an important interface between these layers relates to the establishment of the Data Model for the App.

The Modix Layer defines a set of data classes, called herein Modix Data Classes (also shown in FIG. 2). In an exemplary embodiment, the app developer defines all data objects needed in the app-specific code as subclasses of Modix Data Classes. Any data objects so derived can be managed by the first and second systems of the presently described concepts. An app that uses Modix Data Classes exclusively can be fully restored by these systems, as the complete Data Model for the app is managed by the systems.

A complete Data Model however has one more component, which is a description of how data objects are related by their allowed positions in an object tree. In other words, this defines what types of data objects may be the children of objects of a given type. Typically this is unambiguous when developing for a single platform, but becomes important in cross-platform cases. It is described herein as the Object Tree Map.

### Cross-Platform Data Models

To the practical furtherance of the goal of platform independence, different but similar Modix Layer libraries may be made, suitable for app development on different mobile platforms. App developers who wish to create the same or related apps on multiple platforms, and who wish to extend the advantages of backup, sync, and sharing across multiple platforms, can link to appropriate Modix Layers for their several target platforms. Apps utilizing the same Data Model, even though compiled on different platforms, are equivalent with respect to the data management operations. Backup/restore and sync operations can be performed across them, and data can be shared between them.

For Data Models to be equivalent across platforms, in addition to defining identical data objects, the allowed connections between data objects must be identical as well. This Object Tree Map can be as flexible as the app developer likes, but for the Data Models to be equivalent across platforms, all possible combinations supported by the app-code on one platform must be supported in the app-code of the other platform as well.

### Data Objects, Object Trees and Datasets

Data Objects created by Apps are typically stored locally in the persistent store of the device, and are also typically stored in the AppServer assigned to an App. These Data Objects are related one to another by their position in an Object Tree. Each App has an Object Tree that is unique to itself. This unique tree contains all of the Data Objects of the App. In an exemplary embodiment, this tree, along with ancillary data, constitutes a Dataset for the App, which contains everything needed to restore the data to a replacement App, whether on the same or a replacement device.

One of the features of the current art is that it treats individual Data Objects as independent Objects suitable for sharing, and yet also treats a collection of data as the set needed in a restoration operation.

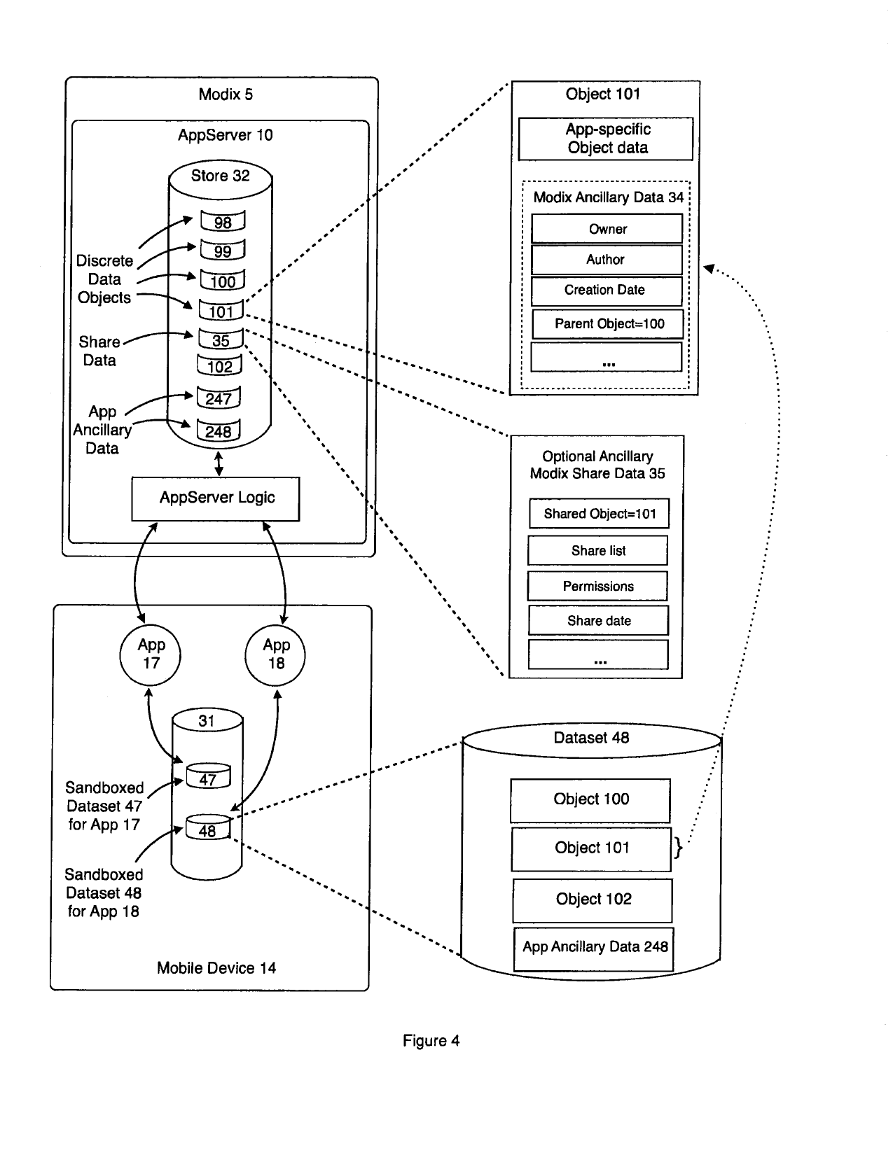

FIG. 4 illustrates this feature, showing an exemplary configuration for representation of Data Objects and Datasets in this system. A typical mobile device platform enforces a sandboxed approach, in which an app cannot access the data related any other app. This is represented in FIG. 4 by an arrow connecting App 17 on Device 14 with a “sandboxed” representation of its Dataset 47 in local storage 31 on Device 14. Likewise App 18 only has access to its sandboxed Dataset 48. Also in FIG. 4, Dataset 48 is shown in expanded view, and contains Data Objects 100, 101, and 102, along with ancillary data 248 related to the App 18, such as its state at closing, user preferences, etc.

FIG. 4 also shows Data Object 101 in an expanded view, revealing details about its management in the Modix. In addition to the app-specific data, which is the data the app developer defined, each Data Object also carries with it details relevant to its existence in the Modix. In FIG. 4 this is represented as the collection of data Objects included within Modix Ancillary Data 34. Also, optionally, as depicted, Data Object 101 is associated with Ancillary Modix Share Data 35 containing details relevant to how it has been shared, such as the share-list, permissions, share date etc. By this it is seen that Object 101 is self-contained, independent of Dataset 48, and capable of being shared as a single unit. FIG. 4 also shows that other Data Objects (in this example, 98 through 101) are stored in the AppServer 10 as separate and discrete objects, perhaps related to other Apps on other Devices.

FIG. 4 also shows as elements in Persistent Store 32 of AppServer 10, App Ancillary Data 247 for App 17, and App Ancillary Data 248 for App 18. App Ancillary Data contains a means of determining a list of the data objects that make up dataset 48, in addition to important data such as the state of the app at closing, user preferences etc. Thus, in an exemplary embodiment, everything needed to restore Dataset 48 to a new device if necessary is maintained on AppServer 10, although not in precisely the same format as stored in the Persistent Store 31 on the Device 14.

Finally, FIG. 4 shows that the Parent Object of Object 101 is referenced in its Modix Ancillary Data 34, making it clear that Object 101 is the child of Object 100. In this manner, the complete object tree is represented.

### App-Contexted, Tree-Based Data Sharing

Sharing is based on the Object tree structure that informs each App's Dataset. When an Object is shared, all Objects attached to it as children are also shared, and the structure is maintained. Thus, although each App has a unique object tree, parts of the tree may be replicated in the object trees within other Apps, when sharing has occurred. To clarify, sharing in this case does not create a separate, duplicate Object. The shared object is one unique object in the system; it just appears in multiple Apps.

FIG. 1, described earlier, showed an example of Data Sharing between App 16 on Device 12 and App 16 on Device 13. Data Sharing was described as between Apps of the same or a related title. This is termed App-contexted Data Sharing and is the fundamental sharing method of this system.

Imagine an app title designed for the creation of a tablet-based newsletter (let's call the app NewsMaker). An author may want to use her NewsMaker App to begin the process, and then hand off portions of it to co-workers, such as other writers to add stories, who may in turn share to other team members: photographers, fact-checkers, editors, and so forth.

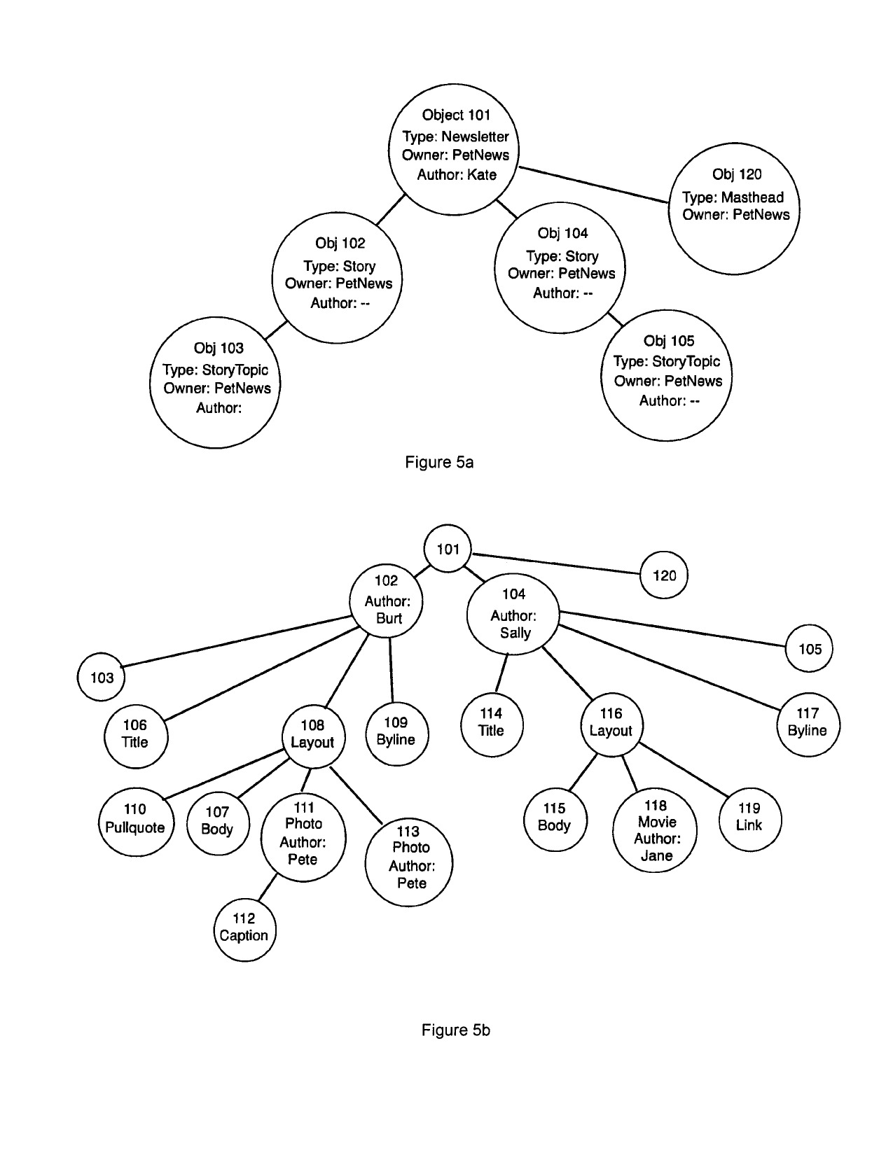

FIG. 5a shows an example of what the object tree for the newsletter might look like when the Editor-in-chief, Kate, is ready to send it to various team members. It is comprised of a root object 101, two story objects 102 and 104, which are placeholders except that each story object has a topic object by which Kate indicates what type of story she wants. Also present in this example is a masthead object 120 containing the names of staff members.

App-contexted Data Sharing means that each member of the team has the same “NewsMaker” app title installed on their device, and is working on the same data object (actually, object tree) within their App, because in this example object 101 was shared to them. The object tree (the work-in-progress newsletter) is shared between Apps acting as components of the Modix. Team members make use of sharing capabilities built into the App to add their contribution rather than sending files by email and then bringing them into an App.

An editor, for example, would open her NewsMaker App, see the work her collaborators have submitted, use the App to make her own contributions or changes, and share these back when ready, or share forward to another team member, all without leaving the App. This is the seamless user experience.

As the work-in-progress newsletter is shared among team members, data objects are created and modified by different team members, and the object tree representing the newsletter grows in complexity. Because it is managed by the Modix, the object tree is assured to remain intact, secure, and backed-up. Ownership, authorship, time stamping and versioning of various components is maintained by the system as well. This is the advantage of using apps backed by a powerful data management system.

FIG. 5b shows an example of how the original object tree from 5a may have grown during the collaborative process. Now story object 102 has an author, Burt, and has child objects as shown in the tree for the title 106, body text 107, and various other elements. Burt is listed as the author of his work, despite that the story, as a child of 102, is owned by PetNews. Photos 111, 113 were included in the story, and their authorship (Pete) is retained by the system. The second story 104 is by a different author, Sally, and includes a movie clip 118 contributed by Jane.

Finally the newsletter is ready to be released. If it is released to viewers who view it through a related app title, for instance called NewsReader, this is still App-contexted Data Sharing, and the processes are the same as the collaborative effort above. Protection against the viewer's making changes can come in two illustrative ways. First, for this example, the NewsReader app is a related app, not the same app; as it was intended for newsletter readers, the app developer would insure that it only has features for reading the newsletters, and lacks any creation or editing functionality. Second, the action of sharing the finished product, object 101, is a separate share action. It is done with a different share-to list (the world rather than specified team members) and it sets a different set of share permissions: in this case “pass-it-on” is enabled for example, while “modify” is disabled. In this way the author can insure that nobody in the “world” share-list can modify the newsletter, even if they have the NewsMaker app.

As described earlier, share operations on an object also share its children, barring instructions to the contrary, so a simple share operation for object 101 to the world shares the completed project represented by the object tree shown in FIG. 5b, with two stories, and all the associated text, photos, layout information, movies, links etc., and proper credit is retained for all contributors.

Using App-contexted Data Sharing makes possible a very seamless user experience. However, unless the data is for internal company use only (such as, in the example given, an internal company newsletter) it is not practical to limit sharing to members of the author's Modix. The second system of the presently described concepts, the Global Modix System, solves this by extending App-contexted Data Sharing across Modixes.

An alternative to App-contexted Data Sharing is Data Publishing, which is another means of communication supported by these systems, and which is based on producing data objects and object-trees formed from publicly-defined Data Classes (such as a Newsletter class) and which therefore can be created by, and viewed by, unrelated app titles, providing they support that public data class. Data Publishing will be described in more detail later in this document.

### Life-Cycle Management of Shared App Data

The secure life-cycle management of app data is one of the primary features of a Modix. Because mobile devices are frequently lost, stolen, or broken, the intended lifespan of data generated thereon extends beyond the life of the device. The system maintains app data, including the data itself and supporting data such as who the data has been shared with and under what conditions, for its intended lifespan.

In a Modix, a key function is to identify the entities who claim authorship, ownership, and other rights to a specific Data Object. The system contains logic to identify the authorship and ownership of each data object, as well as logic to maintain records of the specific rights of other entities to objects that have been shared with them.

In FIG. 4, Optional Ancillary Modix Share Data 35 shows an exemplary record of the list of members the object was shared with, and the permissions (such as read/write/pass-on) selected by the sharer during the sharing operation. Likewise in FIG. 4, the object 101 Modix Ancillary Data 34 shows that the author, owner, creation date and other important facts are retained for the object, both on the device 14 and on the AppServer 10.

In a system with information exchange as a central feature, questions can arise about the intended life-cycle of an object. The original sharer may delete an object after sharing it, but the recipient may want it saved, even after losing their device and acquiring a replacement. This system is designed to manage the data in a way that rights to the data, as specified at the time of the sharing, are maintained for recipients involved in the information exchange.

It was stated earlier that the system provides for backup and restore of app data, including restoring to a different mobile device and even to a mobile device utilizing a different operating system or platform. Now that data sharing has been described, it is clear that these requirements are met by this system even when the data was shared by someone who may no longer be a member of the system.

For example, life-cycle data management includes backup and restore capability, including restoring to a replacement SmartDevice. Data is restored to a replacement SmartDevice that is based on a different operating system or platform than the original device. The life-cycle data management includes the capability to synchronize data with other devices operated by the user, including sync to a SmartDevice that is based on a different operating system or platform than the original device. The life-cycle data management includes cases where the user's intention is to share data objects with other users of the system.

Data sharing is conditional upon acceptance by the intended recipient of said data objects. The data sharing operation is to a specified list of other users. The data sharing operation is a data publishing operation, and in which the allowed recipients are not specified in a list, but rather include the served population of users at large or a defined segment of the served population.

The system is configured to provide data management services for a served entity, which may be an enterprise or other organization, a family, or an individual. The system is configured such that hosting services for a plurality of served entities may be provided by a data services provider on a single system managed by said provider, while having the appearance of a dedicated system to each of the served entities involved. The system is configured such that the served entity may host the necessary server elements on its own server hardware and thus allowing the served entity to provide for its own data security, to provide its own traffic and resource management, and in various other ways to maintain direct control of its data management system. Any or all of the required servers may be virtual servers.

Establishing and maintaining a channel of data sharing within a system between apps on SmartDevices in cases where the data management services for these apps are handled by different AppServers, such that the required authorization, acceptance by the recipient, and connection information for the recipient AppServer are stored, to accelerate data sharing after an initial share and accept sequence is completed.

### Scalability

A Modix must be constantly growing and changing as Apps are added or removed, and as usage creates a changing load on the system. To address these issues, AppServers may be added or removed, as may other specialized servers. This first system provides for massive scalability as demand for services is increased, without noticeable downtime for the user, by providing for adding, removing, or reorganizing AppServers and other specialized servers without taking the system offline.

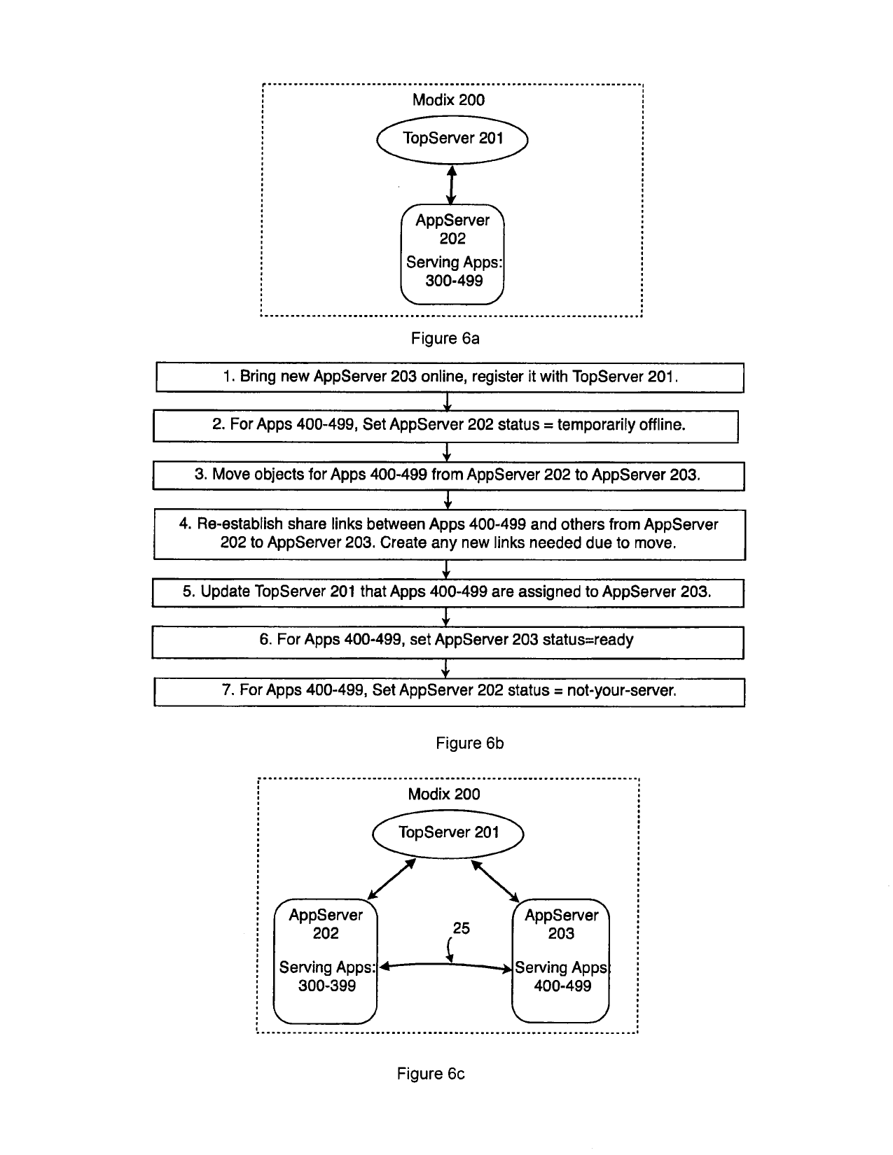

FIG. 6 shows an exemplary structural change and associated algorithm: FIG. 6a represents a starting structure: Modix 200 with TopServer 201 and AppServer 202 which supports Apps 300-499. FIG. 6b shows an exemplary algorithm for adding a new AppServer 203 and moving the related objects for Apps 400-499 to it, creating links as needed between the new AppServer 203 and pre-existing AppServer 202. FIG. 6c shows a resulting structure for Modix 200, in which TopServer 201 is now connected with AppServers 202 and 203, and in which AppServer 202 is assigned to a lesser number of Apps (300-399 compared to 300-499) than was the case in FIG. 6a. Again in FIG. 6c, new AppServer 203 is assigned to Apps 400-499, and new links between this AppServer 203 and pre-existing AppServer 202 are represented by line 25.

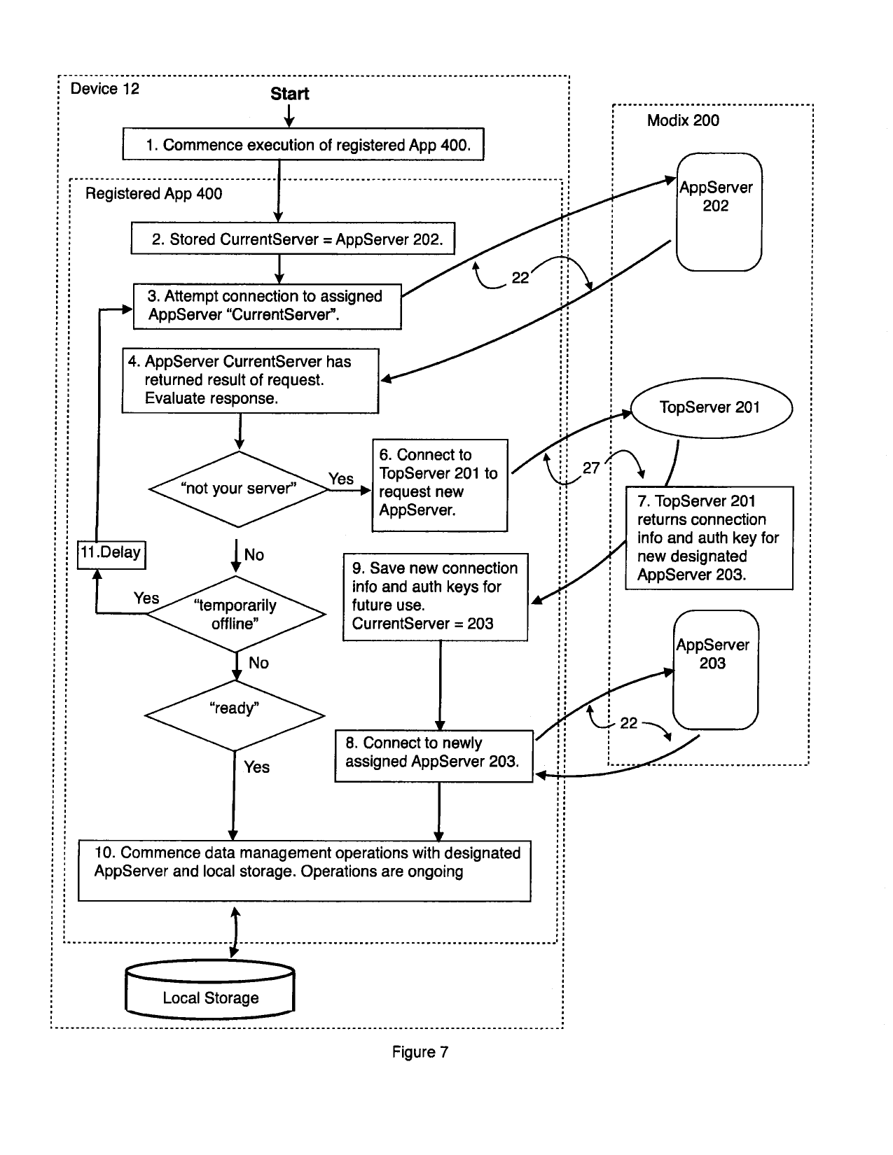

FIG. 7 shows an exemplary algorithm that is complimentary to that shown in FIG. 6b, and which accomplishes the re-assignment of an App to a new AppServer without the involvement of the user and likely without noticeable down time. If, as shown in FIG. 6b, an AppServer is marked “temporarily offline”, the algorithm in FIG. 7, operating in the Modix Layer of an App 400, will delay for a short time and try again. If upon a retry, the result is “not your server” then a connection is made to the TopServer 201, which assigns the new AppServer 203. A connection is made to AppServer 203, which is newly online and has been configured with the necessary data objects to support App 400, and data management services continue uninterrupted.

### Efficiency

The system contains logic to establish efficient communication paths, so that users will experience minimal delays when exchanging information. This is represented in FIG. 1 by the double arrow 25, depicting a direct channel of communication between AppServer 10 and AppServer 11, without the need to pass information through TopServer 7. This may serve to accelerate communications if, for example, the user of App 18 on Device 14 wants to share data with the user of App 18 on Device 15 and vice versa. Simple data sharing in this system is accomplished between two users having the same or related Apps on their separate Devices, and it is not necessary that all of the copies of an App be supported by a single AppServer. So, direct communication channels between AppServers, such as represented by the double arrow 25, accomplish efficient data sharing in these cases. In the algorithm shown in FIG. 6b, the establishment of such a channel 25 is shown as step 4 of the algorithm reconfiguring the Modix structure.

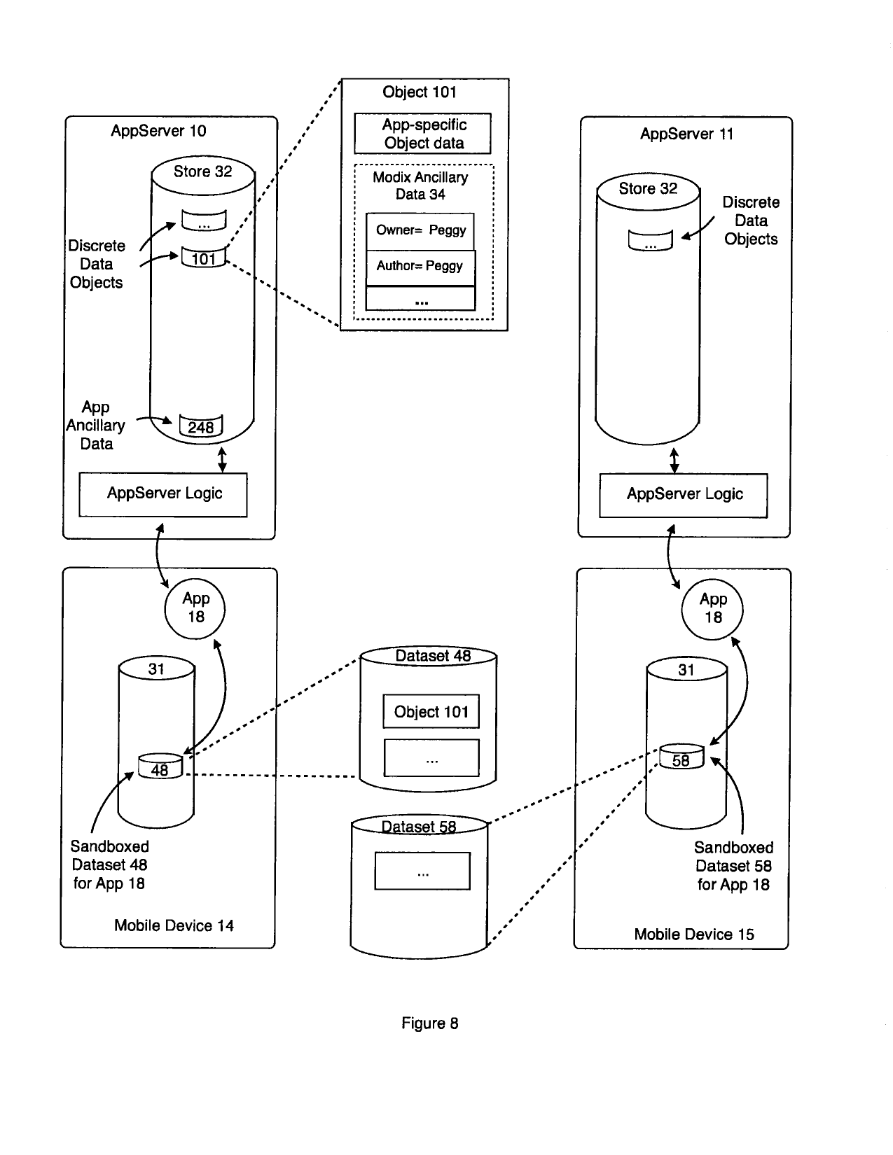

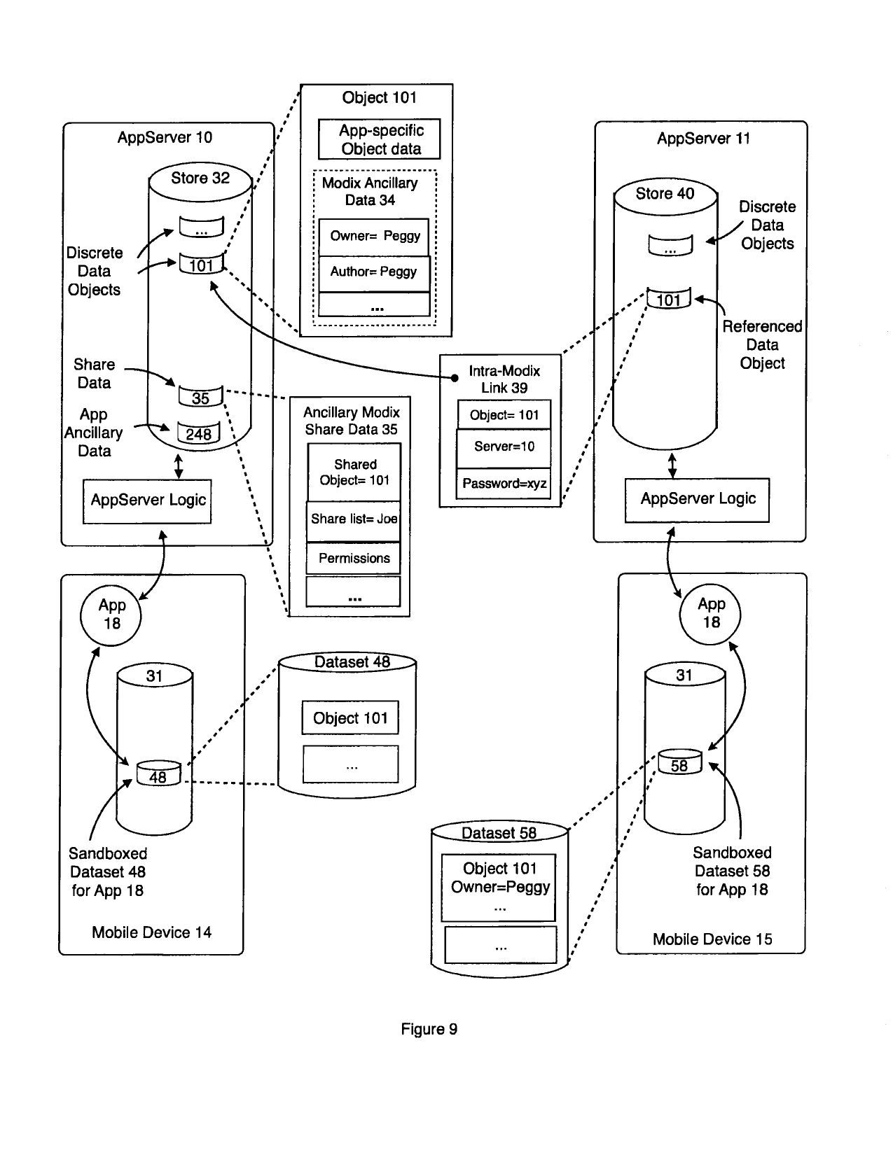

FIGS. 8 and 9 depict exemplary data models before and after a share event involving two AppServers 10 and 11 within the same Modix 5. In FIG. 8, AppServer 10, in support of App 18 on Mobile Device 14, holds the data object 101 owned by PetNews and authored by Peggy, the user of Device 14 in this example. Meanwhile AppServer 11 and App 18 on Device 15 operated by Joe hold no representation of object 101 because it has not yet been shared.

FIG. 9 shows the changes in AppServers 10 and 11 and in Devices 14 and 15 after the user of Device 14 (Kate) shares object 101 with the user of Device 15 (Joe) in the context of their Apps 18. Note that a duplicate of object 101 resides locally on Device 15 in Dataset 58 for immediate use by App 18 on Device 15. Although still owned by PetNews and authored by Kate, object 101 is now included in the Dataset for App 18 on Joe's Device 15. Note also that rather than AppServer 11 holding a duplicate object 101, it's persistent store 40 holds an Intra-Modix Link record 39 that identifies the location of the object (in this example, AppServer 10), along with connectivity information to facilitate a direct retrieval of the object if needed. Finally, notice that information related to the share action is stored as Share Data 35 in persistent store 32 on AppServer 10, related to object 101 residing on the same AppServer 10.

By these methods, efficiency of storage is achieved, in that object 101 is only stored on AppServer 10 while AppServer 11 only stores a link to that, while efficiency of communication is achieved in that, if Kate were to update object 101, this would be communicated to Joe with a minimal number of servers involved: AppServer 10 which communicates directly with Kate's Device 14, and AppServer 11 needed to communicate with Joe's Device 15.

### Description of the Second System (Global Modix System or GMS)

The second system of the present art (called herein a Global Modix System or GMS) is a system that links together multiple first systems, or Modixes, to facilitate data sharing between Apps whose data is managed by different Modixes.

The need for this arises when an individual, family, enterprise or organization has created a Modix to manage its App data, and the members wish to exchange information with others who's related Apps are managed by a different Modix. This was represented in FIG. 1 as a situation where the user of Mobile Device 13 App 17 which is managed by Modix 4, wishes to share data in the context of her App 17 with the user of Mobile Device 14 through his App 17, but his App 17 is managed by Modix 5.

When a Modix is brought online, it is registered with ModixCentral and signals its status as ready to act as a component of the Global Modix System, and ready to accept requests for data management services from installed apps.

In an exemplary embodiment, a Global Modix System (GMS) provides the required connectivity, storage and logic, to facilitate the following data management features:

1. Users whose app data is managed by different Modixes may share data, subject to:
a. Authorization and oversight by management, as defined for a given user
b. Privacy and Security for the shared data, and for other data in the systems

2. Data shared to a user on a different Modix has a lifespan defined by the recipient as well as the sharer.

3. A user on one Modix may discover intended recipients on other Modixes, and obtain permission to share data with them, subject to authorization protocols put in place by the managers of the various Modixes.

4. Shared data, as well as published data, is stored efficiently, avoiding unwanted redundancy but insuring the data's lifespan availability, especially from the recipients' perspective.

5. Ongoing data exchange operations are streamlined for efficient data communications.

### Components of a Global Modix System

A Global Modix System is a system that is comprised of the following:

1. A plurality of Modixes as described in the first system, components of which are fitted with additional special logic to enable them to act as components of this second system.

2. A plurality of Apps as described in the first system which are fitted with additional special logic to enable them to act as components of this second system.

3. An overall controlling component, herein referred to as “ModixCentral,” which consists of elements of logic, data storage, and connectivity residing on a server or servers and which manages and organizes the above components.

### An Exemplary Second System (GMS)

A GMS is constantly growing and changing as Modixes register with and are added to the GMS system. Modixes may also be removed from the GMS system. However, an exemplary snapshot of one simple organization can be seen in FIG. 1.

FIG. 1 shows the ModixCentral 1 in communication with Modixes 4 and 5 as represented by the double arrow lines 20. Modixes 4 and 5 independently manage a number of Apps on Devices as shown.

FIG. 1 illustrates that it is not required that all of the Apps on a Device be supported by the same Modix. Device 13 for example has App 17 supported by Modix 4, and App 18 supported by Modix 5.

For example, a GMS system may provide for worldwide sharing and publishing of data objects between Apps running on SmartDevices (smartphone or tablet-style computing device). An exemplary GMS system may be implemented as a plurality of data-management systems (Modixes), one server (ModixCentral), and algorithmic methods embedded in the ModixCentral. The plurality of data-management systems may be of a design including but not limited to the system described above as the first system, embodied by Modix 4 or 5, each of which is designed to provide life-cycle data management for an app or apps on a SmartDevice or SmartDevices, and includes a server or servers configured to communicate directly with an App or Apps on a SmartDevice or SmartDevices via an AppServer.

The ModixCentral may contain specialized logic, connectivity, permanent storage, and optionally an RDBMS, which specialized logic is designed to interface with the plurality of data-management systems. This includes new systems that may be brought into service during the life of the system. The specialized logic is also designed to interface with Apps running on SmartDevices such as described below as a mobile device, in order to assign a Modix with which said App should connect for its data management. This server (Modix) further contains specialized logic to facilitate the sharing of data objects between Apps on SmartDevices, when the data management for these Apps is handled by different Modixes. Multiple virtual Modixes may be configured on a server to provide data management services for multiple enterprises, organizations, families or individuals, and in which each virtual Modix is represented independently with respect to the ModixCentral.

The algorithmic methods embedded in the ModixCentral system may be embedded such that additional Modixes may be added to the system while the system continues to operate, and therefore defining a system of systems that is massively scalable. Algorithmic methods may further be embedded in the ModixCentral and the Modixes such that shared data is replicated on the recipient's host Modix, and thus providing the recipient with continued access to that data regardless of the availability of the sharer's Modix.

### Sharing Objects Across Modixes in a GMS

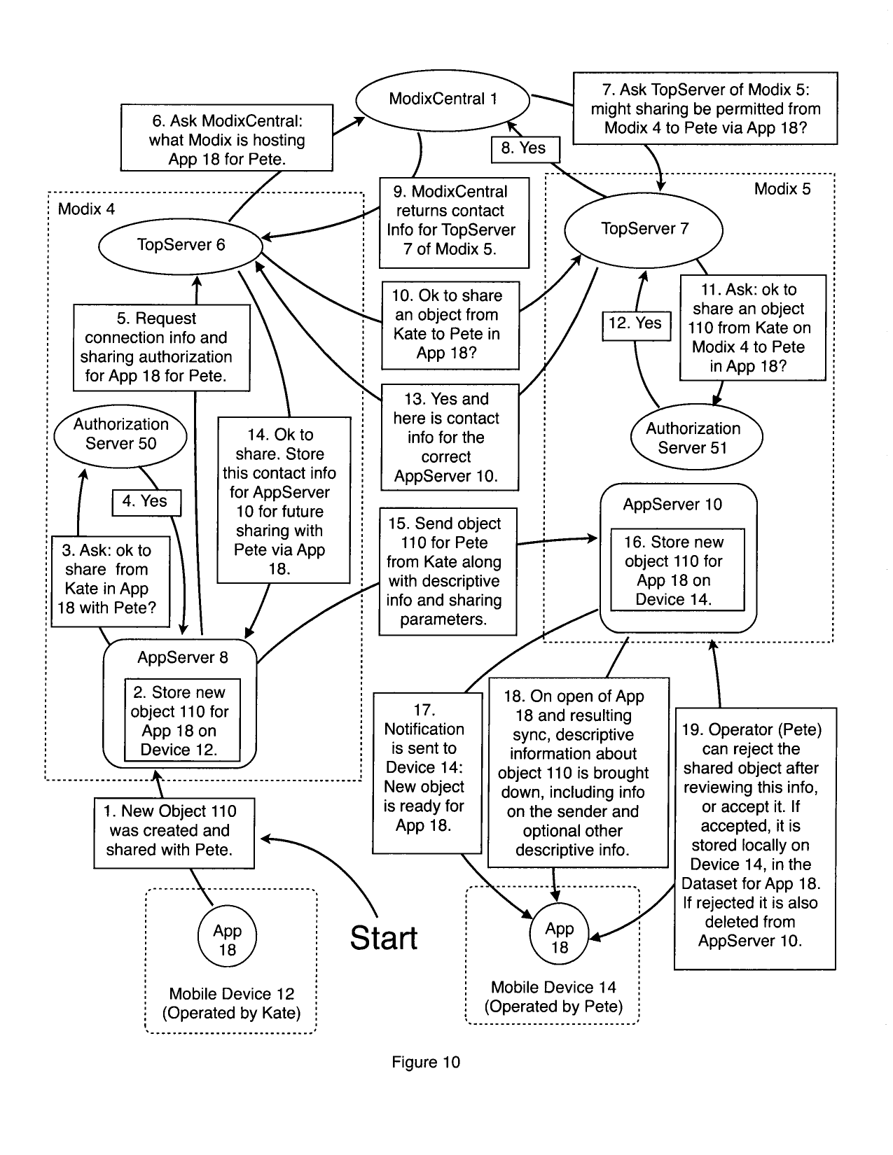

FIG. 10 illustrates an exemplary means of implementing the sharing of data objects in cases where the two Apps involved are supported by different Modixes. Several components are shown here, including ModixCentral 1, independently managed Modixes 4 and 5, and Mobile Device 12 (operated in this example by Kate) with App 18 managed by Modix 4, and Mobile Device 14 (operated here by Pete) with App 18 managed by Modix 5.

Each step of an exemplary sharing operation is numbered sequentially in FIG. 10: The action is initiated in step 1, in which App 18 on Device 12 indicates to its AppServer 8 that a new object 110 has been created and that it has been shared with Pete. Steps 1 through 19, in this FIG. 10, show the progression of a sharing method that is distributed across multiple active components of the GMS. AppServer 8 first stores the new object 110 (step 2) and then asks its own Authorization Server 50 for permission as shown in steps 3 and 4. Authorization Servers are a specific type of auxiliary server found in certain Modix configurations.

Continuing with FIG. 10, in an exemplary embodiment, upon obtaining approval to share from Authorization Server 50, if AppServer 8 has not shared objects between these devices for App 18 previously, and thus has no stored connection info, AppServer 8 then asks its TopServer 6 for the needed connection info and authorization in step 5. TopServer 6, to fulfill this request, requests connection info for the correct Modix from ModixCentral in step 6. This provides the intended receiving Modix (here, Modix 5) with opportunities for authorization steps as shown. ModixCentral, using its internal records, identifies the correct hosting Modix for App 18 on Device 14 as Modix 5. But ModixCentral obtains an initial approval from Modix 5 before sharing its contact info with Modix 4. Modix security and privacy are thus enhanced by steps 7 and 8, wherein a Modix 5 may decline incoming sharing events for this user/App combination, and if declined, Modix 4 does not obtain even basic connection info for Modix 5 or any indication that Modix 5 exists. In this example however, Modix 5 indicates that the share might be allowed, and ModixCentral returns contact info for Modix 5 to Modix 4 in step 9.

Further, this FIG. 10 shows an exemplary instance of an Authorization Server 51 within the structure of Modix 5, and which manages the authorization of object sharing for Modix 5 and in this example, manages incoming share events with more specificity and perhaps more human oversight than that provided in steps 7 and 8. Upon obtaining high level contact info for TopServer 7 in step 9, TopServer 6 then issues a request to TopServer 7 to share an object, providing additional information on the Apps and operators involved, and the object to be shared. Since in this example Modix 5 utilizes an Authorization Server 51, TopServer 7 asks it for approval on the specific share event, as shown in step 11. Operational steps may be delayed, such as for example if Authorization Server 51 is operating an algorithm such that the share request results in the need for a human manager's approval before the share can continue. The operations are asynchronous in that case, until the manager acts on the request.

Note that because TopServer 7 involves Authorization Server 51 before responding to the step 10 share request, if the answer is no, contact info for AppServer 10 is not shared with Modix 4 and in fact no evidence has been provided to Modix 4 that AppServer 10 exists. This is a further example of insulating the components of Modix 5 from malicious attacks. In this example, however, the answer is yes, and therefore the connection info for AppServer 10 is provided to the requester TopServer 6 as shown in step 13. Having received authorizations from its own Authorization Server 50 and from the receiving Modix 5, AppServer 8 can now share the object 110 with the appropriate AppServer 10, to be stored and forwarded on to App 18 on Device 14 operated by Pete, as shown in steps 14, 15 and 16.

Also in FIG. 10, note that a notification can be sent to Device 14 as shown in step 17, and information about the sender and the shared object itself can be brought down as shown in step 18, but the object itself is not sent down yet. This provides an opportunity for the operator (Pete) to reject the shared object, either through a manual action or through the execution of pre-established rules for the acceptance of shared objects, or maintained lists of operators from whom sharing offers will be accepted. In one exemplary method, pre-established rules and maintained lists of approved sharers would be uploaded to the supporting Modix prior to the events shown in this example, and would have been examined as part of the actions of Authorization Server 51 resulting in step 12. But there remains an opportunity for the operator to review information about the sharer and the object, shown being sent to the App 18 on Device 14 in step 18, and to manually reject the share event as described in step 19. Step 19 represents a bi-directional communication between App 18 on Device 14 and AppServer 10, accomplishing the acceptance or rejection of the share, and if accepted, bringing a copy down to App 18 on Device 14 for immediate use.

If the share is ultimately authorized and accepted it is stored on AppServer 10 and also on Mobile Device 14. Now a Channel is established and future sharing between these individuals via this App 18 takes place very efficiently, involving only the apps on the two devices, and the two AppServers, 8 and 10.

In an exemplary embodiment, an App running on a SmartDevice registers with the ModixCentral and thereby obtains connection information for a specific Modix, which Modix will provide data management services for that App. The data sharing service provides for the publication of data objects to a specified list of users, whose apps may utilize various and different Modixes for their data management. The data sharing service may also provide for the publication of data objects to a population of users at large rather than a specified list of users.

As a further example, specialized logic may allow for the registration of an App on a SmartDevice, and the identification and assignment of a specific Modix that may provide data management services for that App on that SmartDevice. The specialized logic may result in maximal efficiency in the movement of data objects through the system in data sharing cases, by the establishment and maintenance of approved channels of data sharing, including direct AppServer to AppServer communication and data replication. Further specialized logic results in minimal redundancy of stored data objects accessed by multiple users in cases involving the publishing of data objects, by providing for a universally accessible data store, and by providing methods for the assignment of pro-rata storage fees for all users of any given data object.

### Description of Additional Implementation Methods

With the above understanding of the first and second systems, and the way data is managed and shared within these systems, it is now possible to describe certain methods, algorithms and procedures by which some of the stated goals of the current art are met. These follow.

### Method for Platform-Independent Representation of Data

One key goal of the present art is to manage app data in a platform-independent manner. This method accomplishes this by converting any locally-originated data from a platform-specific (or “native”) format to a general or common format, in which form it can be managed by the first and second systems. In a complimentary fashion, when remotely-originated data is being sent to an App, whether due to a sharing operation from others or due to a sync or restore operation, this data is converted from the common format to a native format for the local platform on which the App resides.

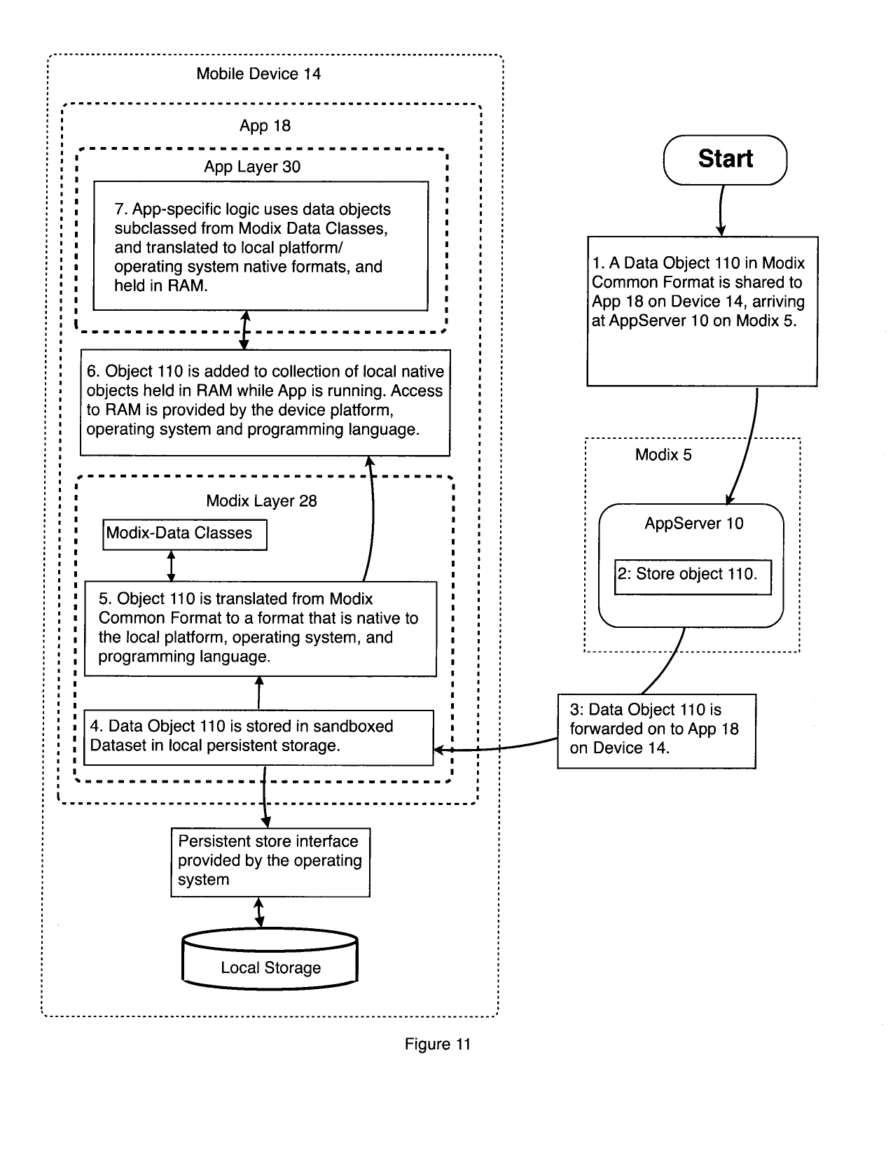

FIG. 11 shows one exemplary method for the translation of data, in this case, from the Modix Common Format to a local native format. The steps 1 through 7 as shown depict the movement of an object 110, first into Modix 5 AppServer 10 in step 1 and stored therein in step 2. Step 3 shows the transfer of object 110 to the Modix Layer 28 of App 18 on Device 14, and stored thereon in the local persistent storage. In Step 5, object 110 is translated by special logic located in Modix Layer 28 from the Modix Common Format into the local native format for Device 14. In step 6 the object is made available to the app-specific logic in App Layer 30 by virtue of being added to a collection of local objects held in RAM in the native format.

While the exemplary description in FIG. 11 shows data conversion to and from native formats being performed within the App 18, format conversion may also occur on the server side of the system. Likewise, FIG. 11 shows the data object 110 being stored in local storage in the Modix Common Format, but translation to native format may just as well be performed prior to saving in local storage. Format conversion in the other direction, from a local native format to the Modix Common Format, and the transfer of such converted data from the Device 14 to AppServer 10 can be inferred from FIG. 11, as being simply the reverse operation from that shown.

As an exemplary practical implementation, a developer can create an app for one platform and link in the appropriate library for that platform, subclassing the named data types defined therein to define app-specific data classes as needed. Then the developer can create the same or a related app for a different platform, linking in the appropriate library for that platform, subclassing the same named data types found in that second library, and defining identical data object class definitions to those in the first app. When these apps, running on different platforms, access the first and second systems for data management and data sharing purposes, the data objects are automatically translated into the common format which can move seamlessly between the different platforms. In this way, a user with an App on one platform can share data with another user with the same or a related App on a different platform.

### Method for Synchronizing Local and Remote Versions of Data Objects

Another key goal of the present art is to maintain a local copy of app data, as well as a remote copy, and to keep these synchronized when the network allows. This allows users to continue to work when out of reach of the network, such as on an airplane. The first system accomplishes this by maintaining a record of which local data Objects have been changed locally but have not been sent to the AppServer, allowing for synchronization to occur at a later time once the network is available.

An exemplary set of operations to implement this method by the systems of the present art includes the use of local device storage, and the queuing up of network operations if there is not currently a network connection.

### Methods for Restoring a Dataset or Installing a Dataset in a Synced Device

The following is an exemplary set of operations that perform a restoration of a dataset to an app on a replacement device, or an initial population of a dataset to an app on a second device at the introduction of said app on said device to the system as one of a synced environment.

### Method for Syncing Multiple Devices

A key feature of a Modix is data synchronization, or “Sync.” Sync refers to the replication of a Dataset onto the same or an associated App on another Device owned or operated by the same User. If a User has multiple Mobile Devices, and has installed the same App on both, they can be configured to be synchronized; that is, they will both show the same Dataset. Changes made to one will automatically be reflected on the other. Sync can also be enabled between related Apps, such as for example an authoring App on one Device, and a viewing App on another Device, provided that both Devices are owned or operated by the same User.

### Method for Data Restore

In the event the App is removed from the Mobile Device, the User can re-install the App. At that point the App, acting as a new installation, invites the user to register the App. By selecting a logic path for re-installations, the User can indicate a desire to recover Data that was generated by the previous installation of the App. After a required identification process has been satisfied, connection information for the appropriate AppServer is given to the App. The App then establishes a connection with that AppServer, in the process of which the AppServer populates the App on the Device with the Dataset that the Mobile Device contained before the App was removed. Upon replacement of the Mobile Device with a newer model, a similar process is repeated as shown in the paragraph above. The result is the same: the installation of the App on the new Mobile Device and the proper identification of the User result in the population of that App with the Dataset created by the previous hardware, provided that is the User's wish.

In an exemplary embodiment, the set of specialized logic is embedded into an app to be installed on a SmartDevice and operated thereon, or made resident on the device and accessible by the app, such that the user is provided with a means to identifying and selecting a system to provide for life-cycle data management for data related to this app. The system may be the second system or the first system as described above, and such that upon the user's selection of such a provider, the app may thereafter make use of said provider for life-cycle data management, The specialized logic may be embedded into an app by inclusion of a pre-compiled library of software, which is then linked together with the unique source code of the app. The specialized logic may also be embedded into an app by the inclusion of a set of source code which is then compiled along with the unique source code for the app. The specialized logic may be embedded by a combination of the above, by including a dynamic library, uncompiled scripting-language, or any other suitable method. The logic may also be embedded in the app and made available to the app by installing a separate program, app, or logic set on the SmartDevice. The logic is accessible to the app at runtime and performs the requisite specialized tasks on behalf of the app, as if the logic were embedded in the app.

The means of selection available to the user, and the further operations of said data-management, is provided with no further involvement involvement of the app developer. The app developer provides a single “hook” or “link” to these functions in the app-specific logic. However, the app developer has no further access to, knowledge of, or responsibility for ongoing data management services.

The means of selection available to the user, and the further operations of said data-management, is provided with no further involvement of the mobile platform provider or the mobile device provider. The mobile platform provider or the mobile device provider provides the normal storage of data within the device for data related to the app, and the normal connectivity available to the app as would be available for any app on a device of its type. The mobile platform provider and the mobile device provider have no further access to, knowledge of, or responsibility for ongoing data management services.

The specialized graphical user interface elements is provided to the user upon running of the app for the purpose of determining a provider of external, life-cycle data management for data related to this app. The graphical user interface allows the user to identify herself or himself by such as, but not limited to, entering a login and password, for purposes of synchronizing data with apps on other devices also owned or operated by this person. The life-cycle data management includes a representation of the managed data that is external to the device itself, and the lifespan of which may exceed the life of the device.

Data objects may be shared and needed to be stored by multiple systems such as the first system and the second system. The data objects may be stored in a shared server as a component of the system, reducing the storage used by the systems to hold only linked to the data objects residing on the shared server. The costs of storage can be distributed to the various systems to the relative numbers of Apps referencing the shared data. The data objects that are published and needed to be stored by multiple systems may be stored in a publication server as a component of the system, reducing the storage used by the systems to hold only links to the data objects residing on the publication server. The published data is locked preventing further changes, and assigned a version number and publication date such that later changes will be identified by a change in the version number and a new publication date. The costs of storage can be distributed to the various systems according to the relative numbers of Apps referencing the published data.

### Communication by Manipulating the Structure of an Object Tree

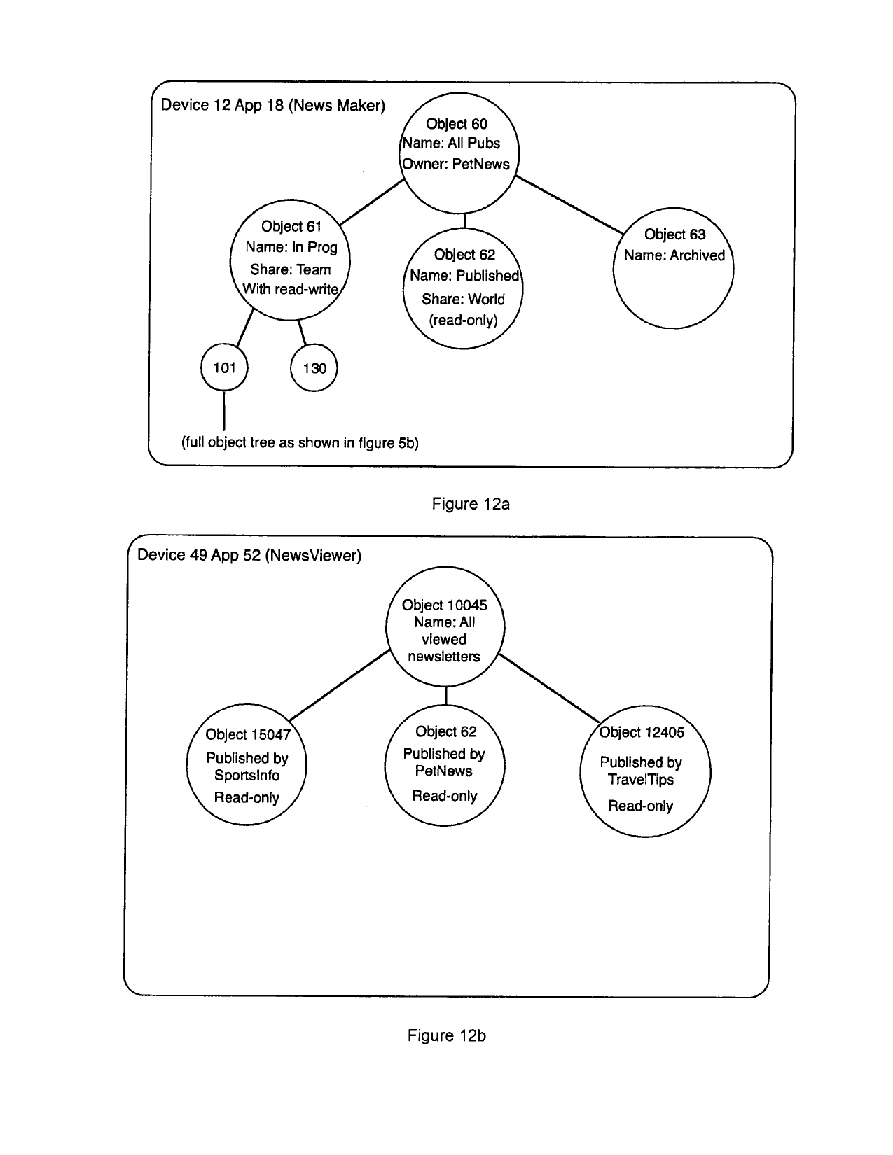

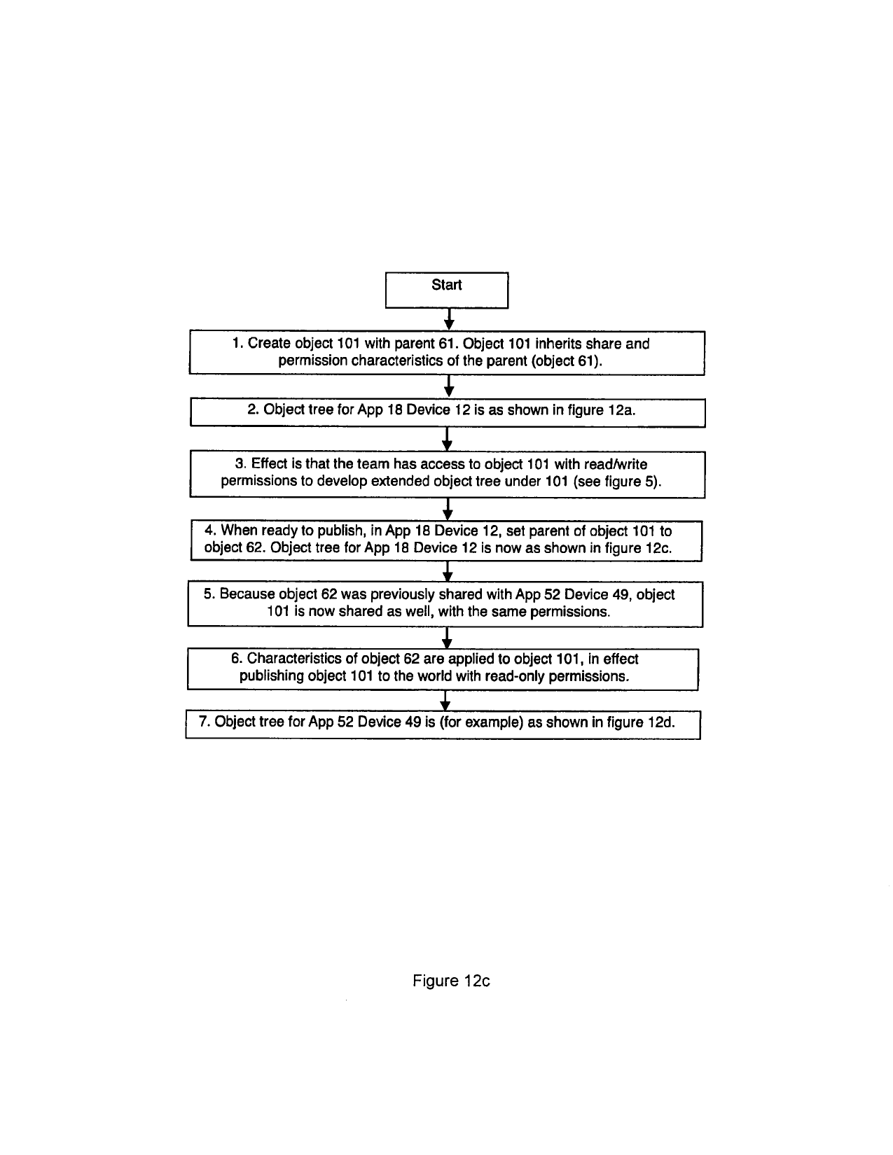

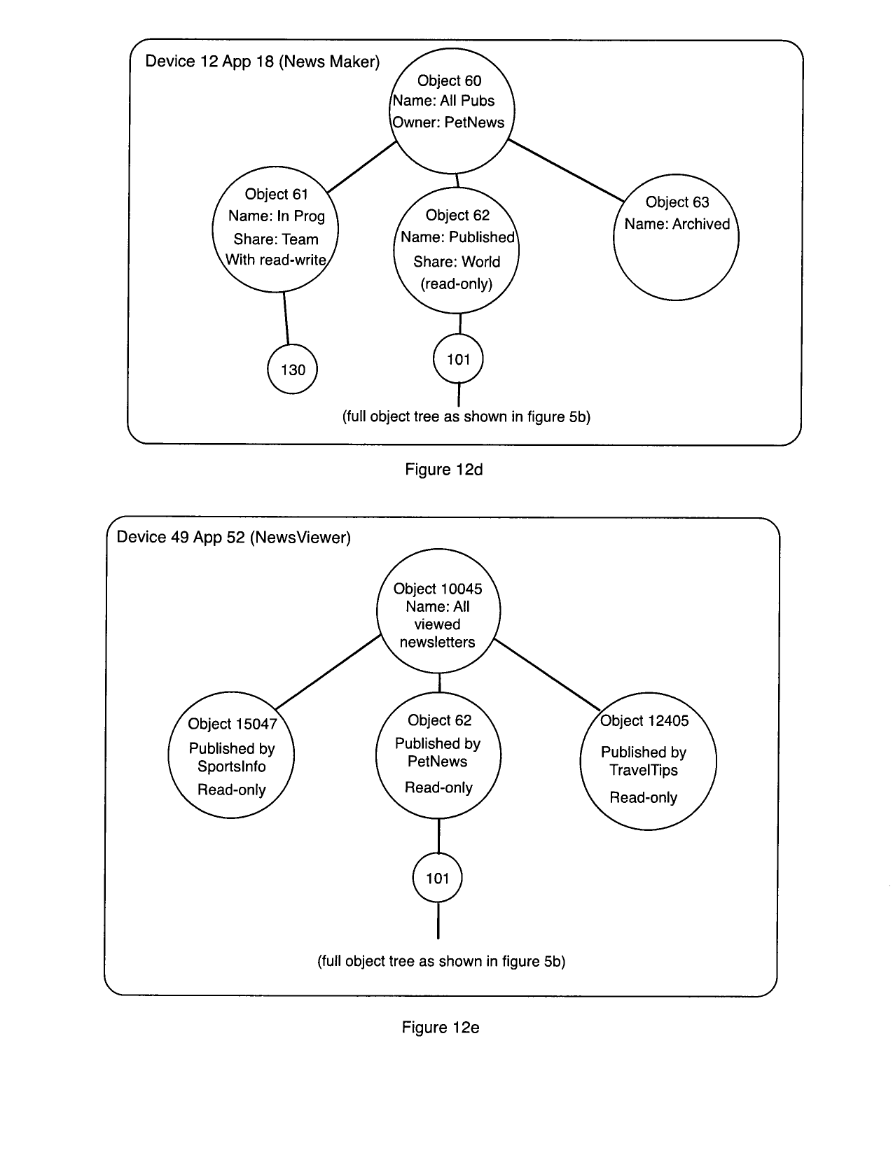

FIG. 12 illustrates an exemplary set of related data objects in which the objects are arranged in a tree structure, exemplary logic for the creation and manipulation of relations between objects and the rearrangement of the object tree, and the resulting communication. FIG. 12a shows an object tree that might exist in an App 18, the NewsMaker App on Device 12. FIG. 12b shows the steps that might be involved in the creation and publication of a newsletter, which is represented by an object tree with object 101 as the root. In App 18, the newsletter object 101 is organized originally under object 61, the works in progress. In that location, it is available to team members, who have read-write permission because object 61 was shared to them in that manner.

FIG. 12b step 4 accomplishes a change in the object tree of App 18 on Device 12. The operator has decided that newsletter object 101 is ready to publish, and causes it to be moved, that is, its parent is reset to be object 62, an organizing object for grouping all published newsletters. Now the object tree for App 18 on Device 12 is as shown in FIG. 12c. The result is that now object 101 inherits characteristics from object 62 instead of 61, and individuals who had previously been shared object 62 immediately receive object 101 (and all of its children, the complete newsletter as shown in FIG. 5b). The object tree for an example viewer is represented in FIG. 12d, in which the newsletter object 101 and its children now appear in the object tree for App 52 of Device 49 (for example) because as a viewer of PetNews, the operator of Device 49 had previously been shared object 49, the organizational object for all newsletters published by PetNews.

### Method for Basic Communication Utilizing a Shared Object Tree

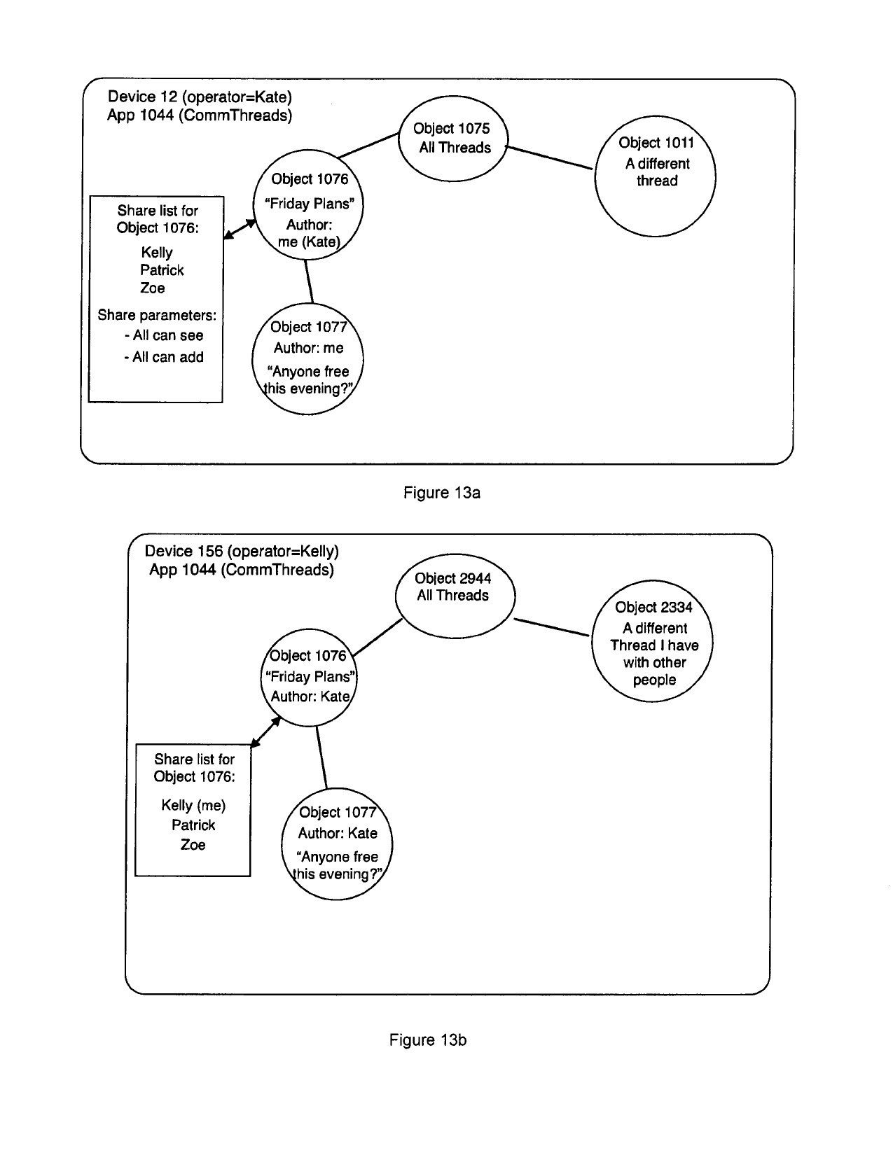

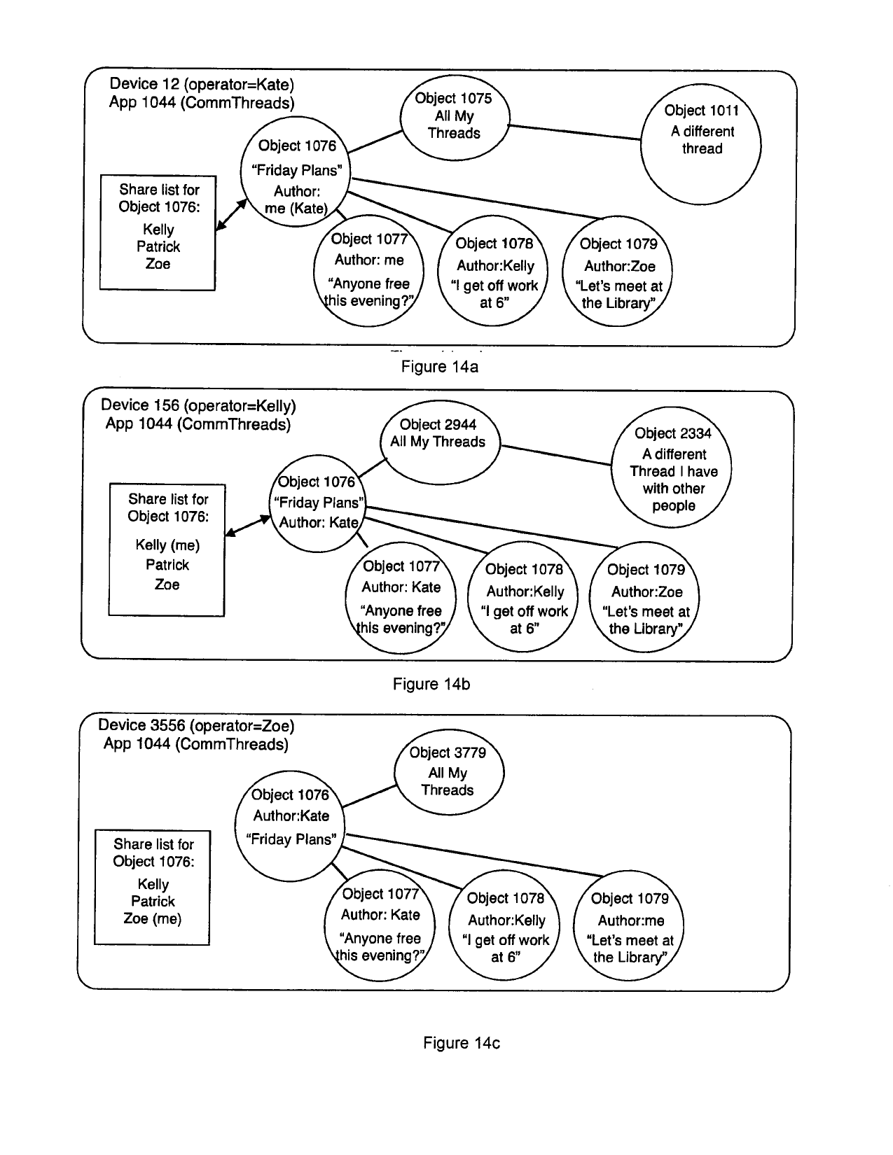

FIGS. 13 and 14 illustrate an exemplary set of transactions implementing a communication scheme via the sharing of a data object with Apps on other Devices with other operators. In FIG. 13, Kate as the operator of Device 12 App 1044 has created an initial object 1076 which carries a string of text: “Friday Plans”. Kate has established a share list for object 1076 which includes operators Kelly, Patrick and Zoe, and has established that all members of the group (the list plus herself) can see all related objects. FIG. 13b represents the object tree on Kelly's Device 156 in App 1044, at a point in time when Kelly has opened the App 1044, viewed the new thread headed by object 1076 from Kate, but has not responded. Note that the object tree headed by object 1076 is mirroring that on Kate's Device 12.

FIG. 14 represents a point in time when Kelly and Zoe, as the operators of Devices 156 and 3556, have each responded, thus adding an object to the object 1076 tree. Kelly added object 1078, and Zoe added object 1079. Because each member's object tree grows with each addition, they can all see the responses from each other member. Patrick, as another member of the group named in the share list, is not represented in these FIG. 13 or 14, but it is clear that so far he has not responded, or his objects would appear in the FIGS. 14a, 14b, and 14c. At a point in the future when Patrick opens his App 1044, the entire tree headed by object 1076 will be duplicated in the object tree for his App 1044, and he will thus be able to see all of the prior entries by other members, and add his own comments.

As shown in FIGS. 14a, 14b, and 14c, each member has a different tree in their App 1044, because of other communication threads they have had within their App. This is represented in FIG. 14a,b,c by the fact that each App/Device has a unique object number as the head of the tree for the App: object 1075 in FIG. 14a, object 2944 in FIG. 14b, and object 3779 in FIG. 14c. However, the portion of each tree beginning with object 1076, and including all sub-objects (children) of object 1076 will be identical in each App, and all objects included in this sub-tree will be identified by the same object numbers throughout the system.

### Method for Object-Based Notification Preferences

When an object is shared to an app on a device, it is sometimes desired that the device produce a notification to the user in some form. Notifications can come to a smart device in several ways: a sound, a vibration, a visible “badge” added to an app's icon to name a few. Typically, apps provide the user with a means of setting the style of notifications, but the selected style apply to all notifications coming to that app. This approach is not sufficient for a system such as this, in which the same app might be used for different threads of communication. Some threads should alert the user immediately with sound or vibration, while other threads within the same app should quietly increment a “new event counter” style of badge on the icon. In keeping with the object based sharing designed into this system, this method provides the framework by which users can select the style of notification on a per-object basis: notification style is a facet of a shared object's metadata, for each party involved. Further, default behaviors can be selected, to only require the user's involvement for the unusual cases.

### Method for Efficient Data Storage in the GMS

When an object is shared to an App which is served by a different Modix than the sharer's App, in order to provide for a possible future data restoration to the recipient App, its Modix must retain a copy of the shared data object (or object tree) in case the sharer's Modix is no longer available or has deleted the object at that future point in time. In order to provide for efficient data storage in these cases, the second system (GMS) can provide a means of storage for data objects such that the objects are marked as required by several Modixes (the sharer's Modix and those of the various recipients) and should not be deleted until all of these Modixes are either no longer part of the system, or indicate that deletion is acceptable.

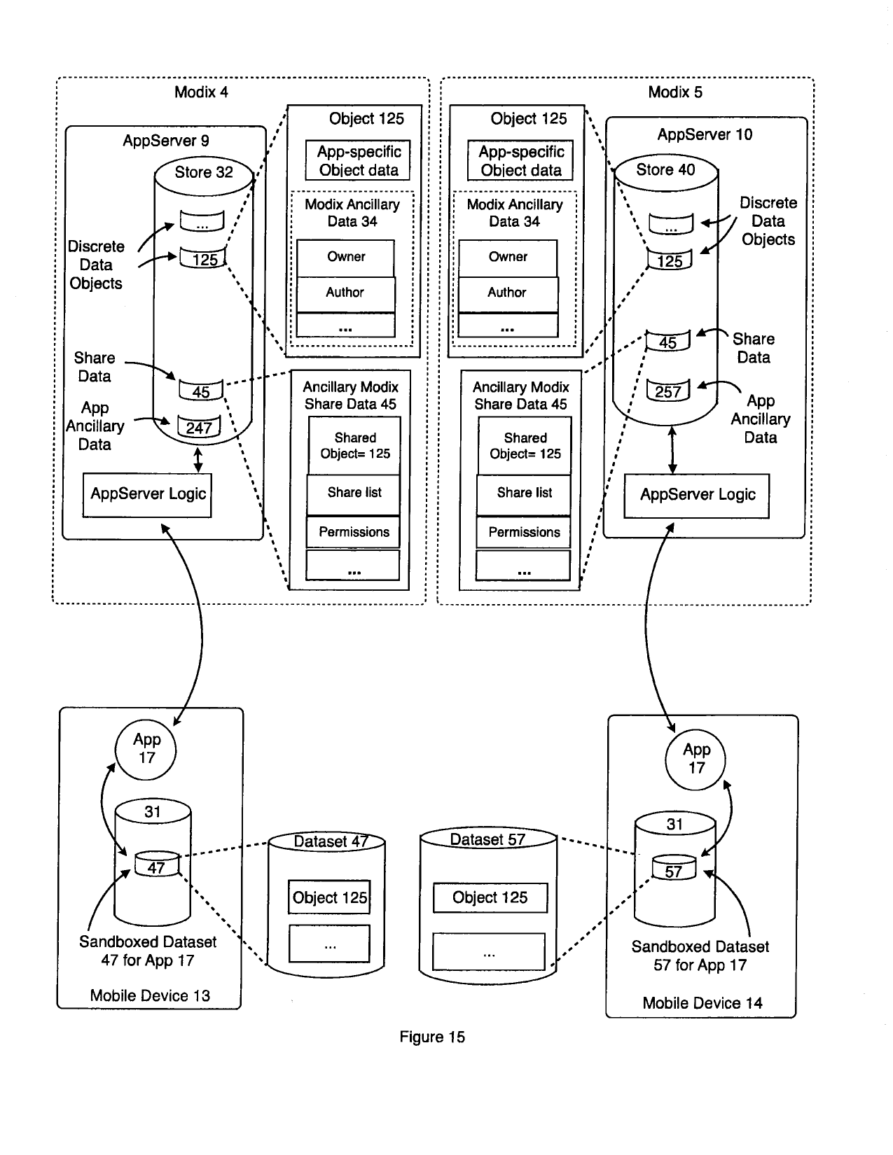

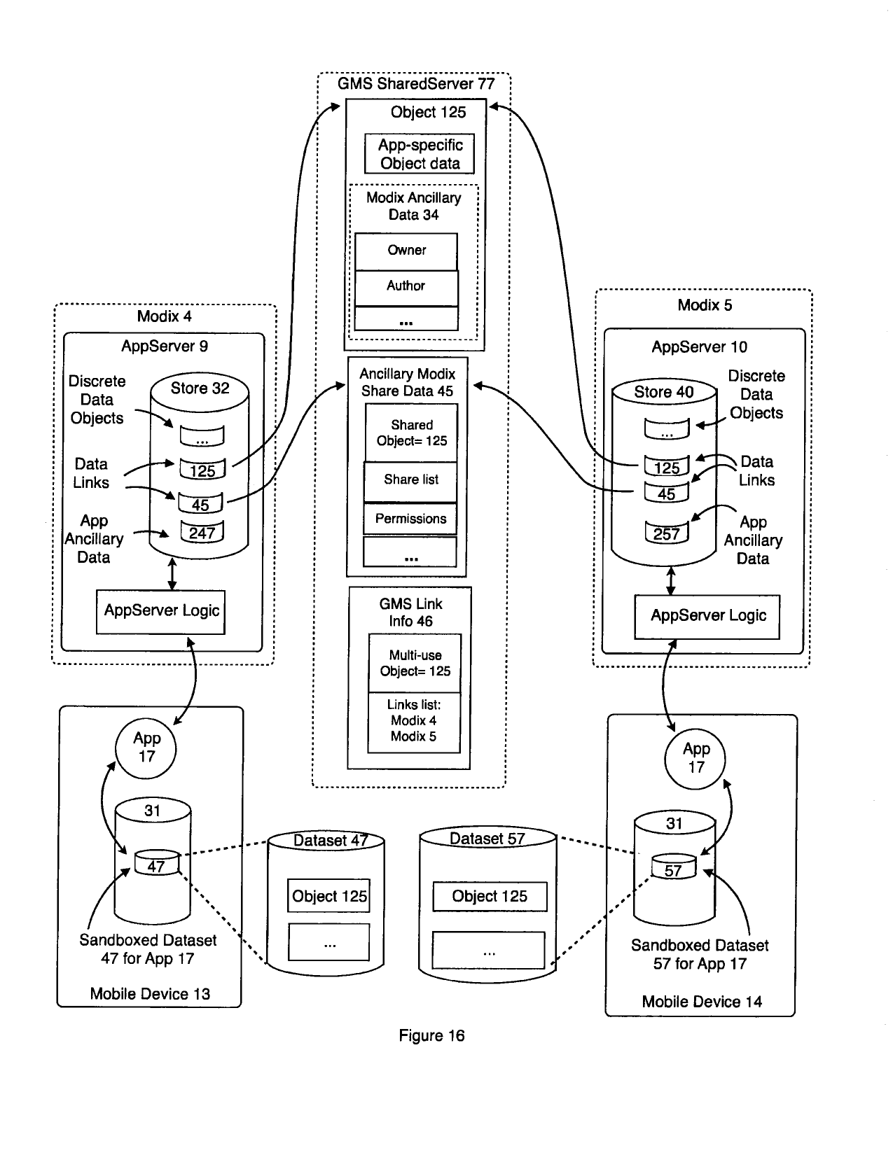

FIGS. 15 and 16 illustrate exemplary configurations by which a Data Object 125 may be managed, and illustrate the efficiency gained by using this method.

In FIG. 15, Object 125 has been shared from an App 17 on Device 13 supported by AppServer 9 in Modix 4 to an App 17 on Device 14 supported by AppServer 10 in Modix 5. The Object 125 has a representation in both Modixes: in AppServer 9, ready for restoration action for Device 13, and in AppServer 10 to provide restoration if needed for Device 14.

Duplication of Data Object 125 on the devices 13 and 14 is beneficial as it provides each App with immediate access to the data, thus enhancing the user experience. Duplication of Object 125 on the AppServers 9 and 10 is inefficient and may offer no benefit in daily use, but is necessary in order for each Modix to offer full restoration capability to the Apps under its management. This situation is common due to the independent nature of a Modix, which may be managed by any entity and which may simply be turned off in the event of bankruptcy or the like.

FIG. 16 shows an exemplary method by which this data redundancy is solved, by the presence of a special facility GMS SharedServer 77 for storing such mutually required Data Objects. In FIG. 16, the relevant data for Object 125, including the object itself and the Ancillary Modix Share Data 45, has been relocated to the GMS SharedServer 77. AppServers 9 and 10 now only store links to this data 125 and 45 on the shared server. Also shown in FIG. 16 in the GMS SharedServer 77 is a new object GMS Link Info 46 which keeps track of Modixes that are currently using Object 125.

### Method for Providing a Publishing System in the GMS

In an exemplary embodiment, when an object is intended to be published rather than shared, an additional set of constraints must be placed on the management of the related data. Recipients of a Published Object reasonably expect that the Object will not change over time, or if it does change, notification of changes and the ability to recover the original must be allowed.

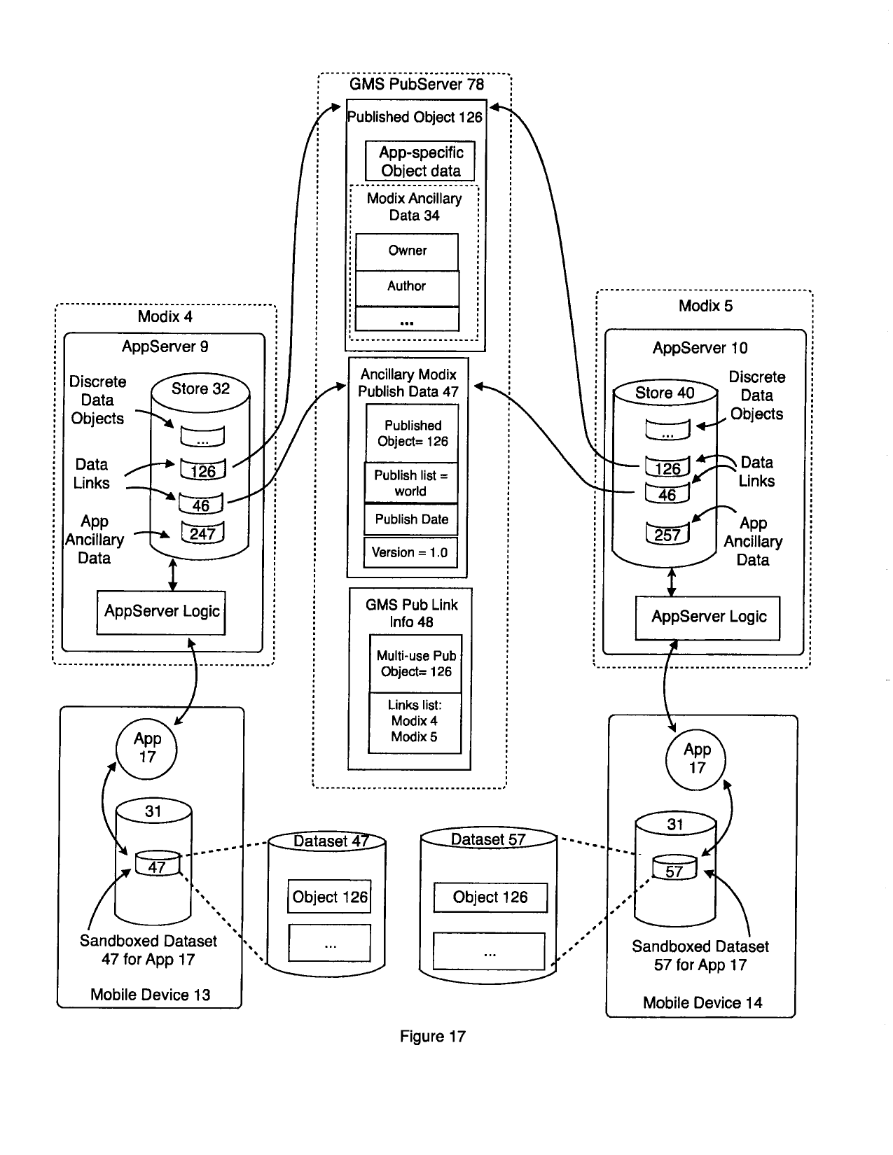

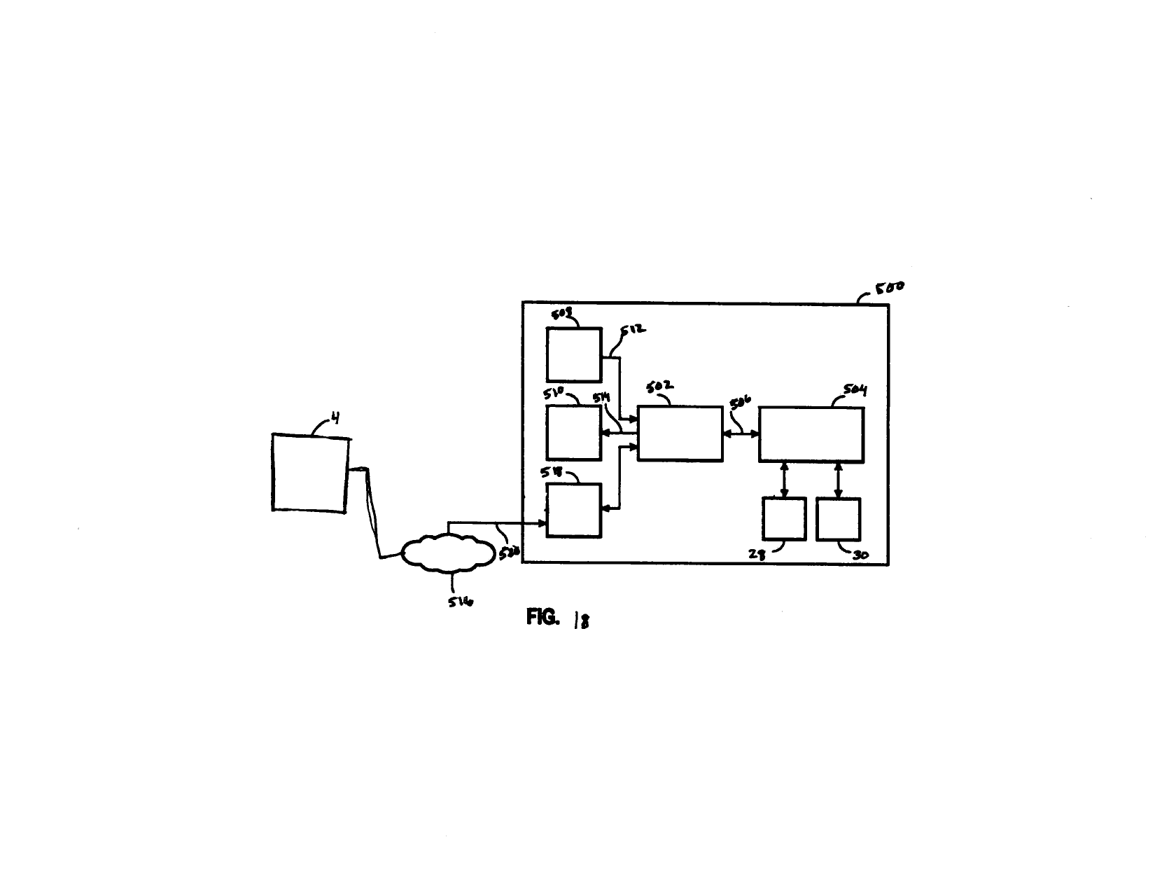

The Modix Publishing System is exemplified in FIG. 17. Note that it shares a great deal of similarity with FIG. 16. One important change is the inclusion of a publish date and a version number. Not shown in the FIG. 17 are additional revisions to the Published Object, with later publishing dates, and incremental version numbers.

FIG. 17 exemplarily illustrates the situation if data Object 126 is published by App 17 on Device 13, rather than being shared. Data related to the Published Object 126, including the Object Data plus ancillary data including but not limited to publication date, author, version number, and a description of the set of allowed viewers, is stored on the GMS PubServer 78. Modixes link to the data stored on PubServer 78 related to Object 126, rather than maintaining discrete copies of the actual Object 126 themselves. As with the GMS SharedServer described earlier, records are kept on PubServer 78 to allow for the pro-rata assignment of hosting costs across a population including the author and the viewers of the published work.

Referring now to FIG. 18, shown therein is one embodiment of a device 500, such as Mobile Device 12, also referred to herein as a SmartDevice. The device 500, in this embodiment, is a mobile device storing mobile Apps having the Modix layer 28 and the App layer 30 with data objects to be backed up, synchronized, or shared using the Modix 4. The device 500 may comprise a processor 502, a non-transitory computer readable medium 504, and the Modix layer 28 and the App layer 30, stored on the non-transitory computer readable medium 504.

The processor 502 may be implemented as a single processor or multiple processors working together or independently to execute the Modix layer 28 and App layer 30 described above and below. Embodiments of the processor 502 may include a digital signal processor (DSP), a central processing unit (CPU), a microprocessor, a multi-core processor, an application specific integrated circuit, and combinations thereof. The processor 502 is coupled to the non-transitory computer readable medium 504. The non-transitory computer readable medium 504 can be implemented as RAM, ROM, flash memory or the like. The non-transitory computer readable medium 504 can be a single non-transitory computer readable medium, or multiple non-transitory computer readable medium's functioning logically together or independently.

The processor 502 is coupled to and configured to communicate with the non-transitory computer readable medium 504 via a path 506 which can be implemented as a data bus, for example. The processor 502 may be capable of communicating with an input device 508 and a display 510 via paths 512 and 514, respectively. Paths 512 and 514 may be implemented similarly to, or differently from path 506. For example, paths 512 and 514 may have a same or different number of wires and may or may not include a multidrop topology, a daisy chain topology, or one or more switched hubs. The paths 506, 512 and 514 can be a serial topology, a parallel topology, a proprietary topology, or combination thereof. The processor 502 is further capable of interfacing and/or communicating with one or more network 516, via a communications device 518 and a communications link 520 such as by exchanging electronic, digital and/or optical signals via the communications device 518 using a network protocol such as TCP/IP. The communications device 518 may be a wireless modem, digital subscriber line modem, cable modem, network bridge, Ethernet switch, direct wired connection or any other suitable communications device capable of communicating between the processor 502, the network 516, and the Modix 4. The processor 502 is capable of reading and/or executing the specialized logic associated with the Modix layer 28 and the App layer 30. The processor 502 is also capable of creating, manipulating, altering, and storing data objects and computer data structures into the non-transitory computer readable medium 504.

The non-transitory computer readable medium 504 stores the Modix layer 28 and the App layer 30 and may be implemented as random access memory (RAM), a hard drive, a hard drive array, a solid state drive, a flash drive, a memory card, or the like, as well as combinations thereof. When more than one non-transitory computer readable medium 504 is used, one of the non-transitory computer readable mediums 504 may be located in the same physical location as the processor 502, and another one of the non-transitory computer readable mediums 504 may be located in a location remote from the processor 502. The physical location of the non-transitory computer readable mediums 504 may be varied and the non-transitory computer readable medium 504 may be implemented as a “cloud memory,” i.e. non-transitory computer readable medium 504 which is partially or completely based on or accessed using the network 516.

The input device 508 transmits data to the processor 502, and can be implemented as a keyboard, a touch-screen, a camera, a track ball, a microphone, a network adapter, and combinations thereof. The input device 508 may be located in the same location as the processor 502 and communicate with the processor 502 via path 512.

The display 510 transmits information from the processor 502 to a user, such that the information can be perceived by the user. For example, the display 510 may be implemented as a touch-screen or a non-touch LCD screen. The display 510 communicates with the processor 502 via the path 514.

The network 516 may permit bi-directional communication of information and/or data between the processor 502, the network 516, and the Modix 4. The network 516 may interface with the processor 502 in a variety of ways, such as by optical and/or electronic interfaces, and may use a plurality of network topographies and protocols, such as Ethernet, TCP/IP, circuit switched paths, file transfer protocol, packet switched wide area networks, and combinations thereof.

When the device 500 is implemented as a SmartDevice or mobile device 12, the processor 502, non-transitory computer readable medium 504, the input device 508, the display 510, and the communication device 518 may be implemented together as a smartphone, a PDA, a tablet device, such as an iPad, a netbook, or a laptop.

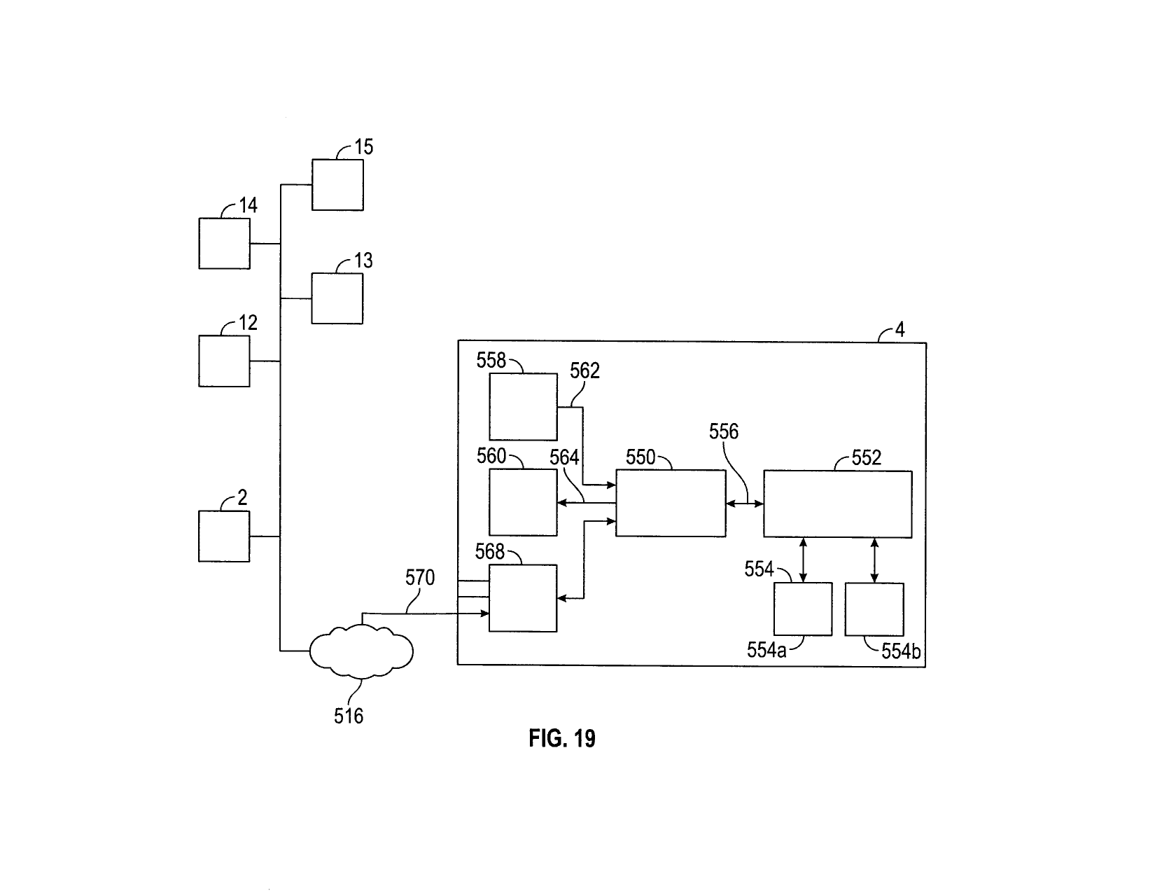

Referring now to FIG. 19, shown therein is an embodiment of the first system 4 comprised of a set of physical or virtual computing components which may contain specialized logic, storage and connectivity. The first system 4 may serve as a data management structure for data related to apps installed on mobile devices to be operated by members of an entity. The first system 4 may be logically or physically divided into the TopServer 6 and the plurality of AppServers 8, for example, with the TopServer 6 managing the changeable structure of the system, and the plurality of AppServers 8 communicating directly with the plurality of installed and registered apps under the first system's 4 management. The first system 4 may be implemented as one or more server, load balancing server, virtual servers, web servers, application servers, or the like.

In an exemplary embodiment, the first system 4 may comprise a processor 550, a non-transitory computer readable medium 552, and specialized logic 554 stored on the non-transitory computer readable medium 552 enabling the first system 4 to serve to manage Mobile App Data. Although shown in this embodiment as a single physical system logically divided between the TopServer 6 and the plurality of AppServers 8, it will be understood by one skilled in the art that the first system 4 may be divided physically with the TopServer 6 and the plurality of AppServers 8 each having substantially similar components.

The processor 550 may be implemented similarly to the processor 502 described above, as a single processor or multiple processors working together or independently to execute the specialized logic 554 described above and below. The processor 550 is coupled to the non-transitory computer readable medium 552. The non-transitory computer readable medium 552 can be implemented similarly to the non-transitory computer readable medium 504, for instance as RAM, ROM, flash memory or the like, and may take the form of a magnetic device, optical device or the like. The non-transitory computer readable medium 552 can be a single non-transitory computer readable medium, or multiple non-transitory computer readable medium functioning logically together or independently.

The processor 550 is coupled to and configured to communicate with the non-transitory computer readable medium 552 via a path 556 which can be implemented similarly to the path 506. The processor 550 may be capable of communicating with an input device 558 and an output device 560 via paths 562 and 564, respectively. Paths 562 and 564 may be implemented similarly to path 556. The processor 550 is further capable of interfacing and/or communicating with one or more network 516, via a communications device 568 and a communications link 570 such as by exchanging electronic, digital and/or optical signals via the communications device 568 using a network protocol such as TCP/IP. The communications device 568 may be a wireless modem, digital subscriber line modem, cable modem, network bridge, Ethernet switch, direct wired connection or any other suitable communications device capable of communicating between the processor 550, the network 516, the second system 2, and the plurality of mobile devices 12-15.

The input device 558 transmits data to the processor 550, and can be implemented as a keyboard, a mouse, a touch-screen, a network adapter, a server, and combinations thereof. The input device 558 may be located in the same location as the processor 550, or may be remotely located and/or partially or completely network-based. The input device 558 communicates with the processor 550 via path 562.

The output device 560 transmits information from the processor 550 to a user, such that the information can be perceived by the user. For example, the output device 560 may be implemented as a server, a computer monitor, a cell phone, a tablet, a speaker, a website, a PDA, a fax, a printer, a projector, a laptop monitor, and combinations thereof. The output device 560 communicates with the processor 550 via the path 564.

The specialized logic 554 may be implemented as processor executable instructions 554a enabling the first system 4 to serve to manage Mobile App Data as described above and below, as well as other processor executable instructions 554b, such as operating systems, and the like. The processor executable instructions 554a may be implemented to enable communications between TopServers 6 and the plurality of AppServers 8-11, where those elements are implemented as physically separate systems.

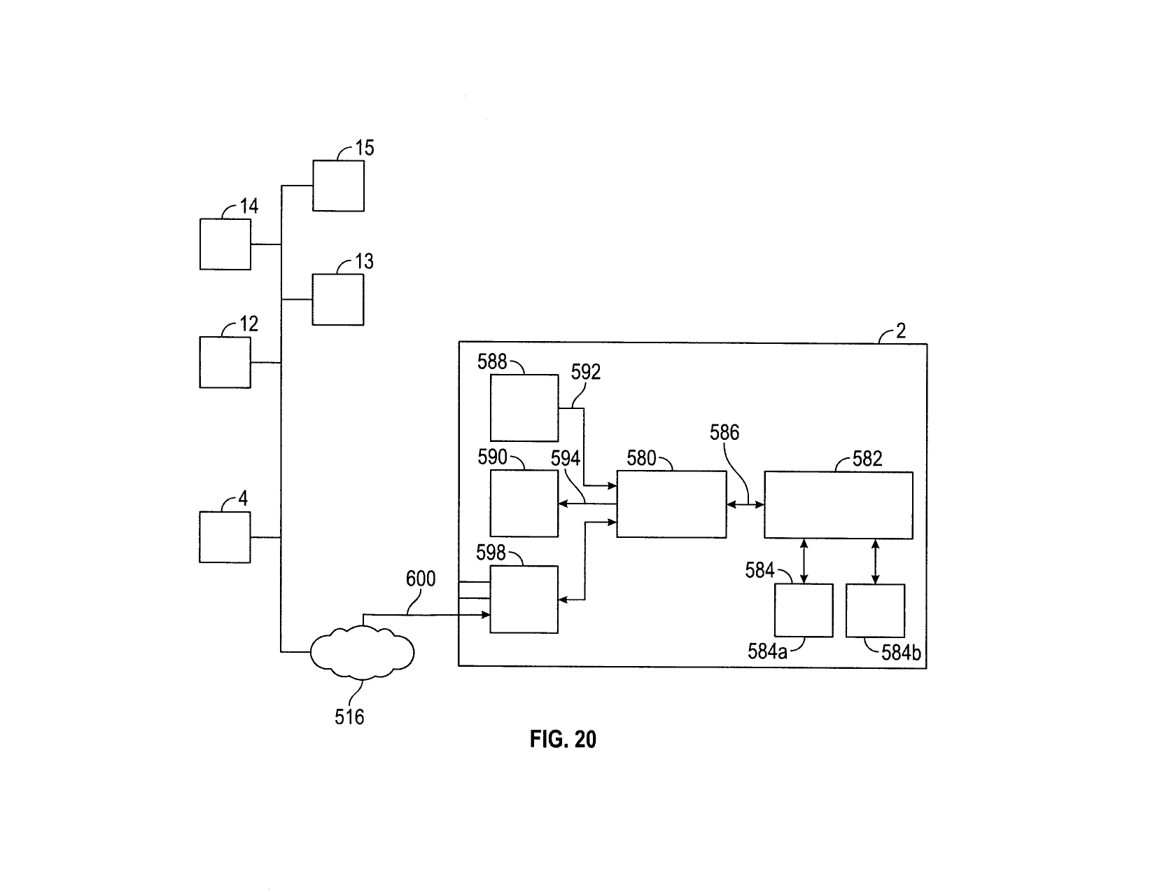

Referring now to FIG. 20, therein shown is an exemplary embodiment of the second system 2, the Global Modix System. The second system 2 links together multiple first systems 4, such as Modix 4 and Modix 5 to facilitate data sharing between Apps whose data is managed by different Modixes. Individual Modixes are brought online and registered with the second system 2 such that the individual Modixes may accept requests for data management services from apps installed on mobile devices. The second system 2 may be implemented as one or more server configured to operate as a singular top level Modix system, containing logic to identify and map various Modixes, entities, apps, and devices to facilitate connections between them.

In an exemplary embodiment, the second system 2 may be provided with a processor 580, a non-transitory computer readable medium 582, and specialized logic 584 stored on the non-transitory computer readable medium 582.

The processor 580 may be implemented similarly to processor 550, as a single processor or multiple processors working together or independently to execute the processor executable instructions 584 described herein. Embodiments of the processor 580 may include a digital signal processor (DSP), a central processing unit (CPU), a microprocessor, a multi-core processor, an application specific integrated circuit, and combinations thereof. The processor 580 is coupled to the non-transitory computer readable medium 582. The non-transitory computer readable medium 582 can be implemented as RAM, ROM, flash memory or the like, and may take the form of a magnetic device, optical device or the like, similarly to the non-transitory computer readable medium 552. The non-transitory computer readable medium 552 can be a single non-transitory computer readable medium, or multiple non-transitory computer readable medium functioning logically together or independently.

The processor 580 is coupled to and configured to communicate with the non-transitory computer readable medium 582 via a path 586 which can be implemented as a data bus, for example, similar to path 556. The processor 580 may be capable of communicating with an input device 588 and an output device 590 via paths 592 and 594, respectively. Paths 592 and 594 may be implemented similarly to, or differently from path 586.

The processor 580 is further capable of interfacing and/or communicating with the one or more network 516, via a communications device 598 and a communications link 600 such as by exchanging electronic, digital and/or optical signals via the communications device 598 using a network protocol such as TCP/IP. The communications device 598 may be a wireless modem, digital subscriber line modem, cable modem, network bridge, Ethernet switch, direct wired connection or any other suitable communications device capable of communicating between the processor 580, the first system 4, and the plurality of mobile devices 12-15. It is to be understood that in certain embodiments using more than one processor 580, the processors 580 may be located remotely from one another or located in the same location. The processor 580 is capable of reading and/or executing the specialized logic 584 and/or creating, manipulating, altering, and storing computer data structures into the non-transitory computer readable medium 582.

The non-transitory computer readable medium 582 stores specialized logic 584 and may be implemented as random access memory (RAM), a hard drive, a hard drive array, a solid state drive, a flash drive, a memory card, a CD-ROM, a DVD-ROM, a BLU-RAY, a floppy disk, an optical drive, and combinations thereof, similar to the non-transitory computer readable medium 552.

The input device 588 transmits data to the processor 580, and can be implemented similarly to the input device 558. The input device 588 communicates with the processor 580 via path 592.

The output device 590 transmits information from the processor 580 to a user, such that the information can be perceived by the user, similar to the output device 560. The output device 590 communicates with the processor 580 via the path 594.

The specialized logic 584 may be implemented as processor executable instructions 584a for the data sharing, backup, and data management described above and below, as well as other processor executable instructions 584b, such as operating systems, and the like.

### FURTHER DETAILED DESCRIPTIONS OF THE SYSTEMS AND METHODS

### Definitions

The descriptions of a first system (Modix) and a second system (Global Modix System) herein make use of the following definitions. These definitions are for the purpose of the presently described concepts, and are typically more specific than common usage.

### Modix

The term “Modix” refers to the first system described in this patent application.

### ModixCentral

“ModixCentral” is a Server configured to operate as the singular and only top level to the Global Modix System. It contains logic to identify and map various Modixes, Entities, Apps, and Devices, and to facilitate connections between them as required.

### Modix Sharing System

The previous definition of Modix is extended as follows: The “Modix Sharing System” operates within the Global Modix System.

### Individual and Modix Login

An “Individual” refers to a person who may take action with respect to a mobile app, the data of which is managed by a Modix. An Individual is identified to the Modix by a reference to a “Modix Login.” A Modix Login refers specifically to one Individual, but an Individual may create multiple Modix Logins.

### Entity

An “Entity” refers to an Individual, as identified by a Modix Login, who may be the author of certain data and may claim certain rights to that data thereby, or who may be the recipient of shared information and may also claim certain rights to that data. An Entity may also be an enterprise or organization responsible for the creation and maintenance of a Modix.

### Global Modix System or System

The “Global Modix System” or the “System,” is the second system described herein, and is a system comprised of a plurality of components including but not limited to computers, mobile devices, and personal computers, each component of which is fitted with logic, data storage, and connectivity as needed to perform a defined set of functions within the system. Further, let this definition include the description above, labeled “Overview of the Second System (Global Modix System).”

### Global Modix System Authority

The “Global Modix System Authority” is the individual, enterprise, or organization that maintains control over and management responsibilities for the Global Modix System. The Global Modix System Authority is responsible for maintaining components of the Global Modix System that are not maintained by other Entities.

### Modix, Private Modix, and the Public Modix

The previous understanding of the first system is extended as follows: A “Modix” may be a subset of a Global Modix System which is made up of a plurality of Servers; these Servers are organized to function together to provide a set of Modix System Services to an Individual or other Entity. A Modix functions within the Global Modix System as a self-contained unit of logic, storage, and connectivity. That is, to components of the System outside of the Modix, each Modix functions as a single unified System component.

A “Private Modix” is a Modix that is created and operated by or for an entity such as an enterprise, family, or individual, for the purpose of managing relevant data from Apps used by or for that entity.

A “Public Modix” is a Modix that is provided and maintained by the Global Modix System Authority, to provide Modix System Services to any Individual or other Entity who, with respect to a Registered App, does not wish to be affiliated with a Private Modix, and does not wish to establish a dedicated Private Modix for the Data in question.

### Modix System Services

The term “Modix System Services” refers to a set of services that a Modix provides to Entities for the management of data generated by the use of Modix-Enabled Apps (“Apps,” as defined below) running on Mobile Devices, which Apps are managed by a Modix. The term may also refer to a set of services that a GMS provides.

### Modix System

The term “Modix System” is a way of referring to a Modix, or a collection of Modixes combined in a GMS.

### Server

A “Server” is a computer fitted with specialized logic, data storage, and connectivity, and configured to be a component of a Modix and/or of a GMS. It can connect and communicate with other components of the Modix or GMS, and other components may connect and communicate with it, according to the rules of the system. A Server does not communicate with anything outside of the Modix. That is, while Modix-Enabled Apps and other Servers in the Modix may connect with and exchange data with a Server, a Server will not respond to a web browser or an independent computer program. A Modix is a closed system in that regard.

Servers are different from mobile devices in that they are characterized as having long-term permanence by virtue of their physical location, facility for permanent storage, and/or hosting hardware and software.

A Server may be a distinct physical hardware unit, or a virtual Server sharing a physical unit with other Servers.

### Mobile Device or Device

A “Mobile Device” or “Device” is defined as: a mobile phone, tablet, or other such physical device which can: 1) run a mobile App, 2) store local data related to that App, and 3) communicate with Servers via a data network. A Device is uniquely identified within the Modix and within the GMS by a Device ID number.

### Device Owner

A “Device Owner” for a Device is the Entity that owns the Device and has the right to its management, control, and ultimate disposition. A Device can only be associated with one Device Owner. Ownership of a Device does not automatically convey ownership of all of the Data stored on the Device.

### Device Operator

A “Device Operator” is an individual who has a one-to-one relation to a Device, being the sole Individual who physically manipulates the Device and runs the Apps thereon. It is not necessary to identify a Device Operator for a Device, but doing so can streamline some processes, such as help in the recovery of a lost Device. In one embodiment, if a Device is associated with a Device Operator, it must be associated with only one Device Operator.

### Modix-Enabled

An app that is “Modix-Enabled” follows the rules for Apps in the Modix System, and contains logic that enables it to take advantage of Modix System Services. As a minimum, when executed on a Mobile Device, a Modix-Enabled App can: 1) identify itself by type, such as by a unique app name and optionally a version number, and 2) uniquely identify the Developer of the App Title to the System.

### App Developer or Developer

An “App Developer” or “Developer” is an Individual or company or the like that creates an app intended to be installed on Mobile Devices and to operate as a component of a Modix. In one embodiment, a Developer must be registered with the Modix System such that an App may identify its Developer to the System.

### App Title

An “App Title” describes the result of a Developer's effort as a software program ready to be distributed. For a given App Title, each time it is installed and registered, the resulting Registered App (“App”) is a unique active component of a Modix. In one embodiment an App Title must have been created in conformance with standards and practices such that, once installed and registered, the resulting App is Modix-Enabled. An App Title may be developed and distributed by an Entity for its own use, or copies of it may be acquired from a third-party Developer.

### Registered App or App

The term “Registered App” or “App” means an App Title that has been installed on a Device, and has been run, in the process of which running a registration process has been completed, which associates the App with a Modix. The capitalized term “App” is used throughout this document and refers always to an app title that has been registered with a Modix and is thus an active component of a Modix, and perhaps of a GMS.

### App Data or Data

“App Data” or “Data” is any data that is generated by the operations of an App, including but not limited to: 1) data that is necessary to recreate the exact behavior of an App if restored to a replacement Device, 2) data that is deemed of sufficient lasting value, either by the App Developer or by the Operator (if given the choice) that it may be selected for restoration or recovery later, 3) information on the status of the App or the User's preferences, 4) information entered into the App by the Operator, including by typing, speaking, moving the Device, or other means, 5) information sent to the App from outside, such as from webservers, GPS satellites, or information services, 6) information searched for and retrieved by the App, 7) information shared by other App Operators, and 8) information published, either by other App Operators or by any others if published in a form that can be operated on by the App.

### Operator or User

An “Operator” or “User” refers to the Individual who's Modix Login is given when registering an App on a Device. This is the Individual who will be using that App on that Device. In the Modix System, there can be only one installation of a specific App on a Device, so there can be only one Operator for an App on a Device. By virtue of this one-to-one relation, the Individual connected to that Modix Login is the unambiguous author of Data created by that App on that Device.

### Dataset

A “Dataset” is the complete collection of Data plus ancillary or meta-data (such as preferences, bookmarks, status) that makes up the sum total of Data stored (or, for portions of Data not stored locally, held in reference) by a Registered App. A Dataset is unique for a given combination of App and Operator, even if for no other reason than belonging to that combination. A Dataset includes Objects shared to the Operator of the Registered App. A Dataset also includes Published Objects for which the Operator has become an Audience, or links to these.

### Object or Data Object

An “Object” or “Data Object” is a discrete set of data that makes up one cohesive, identifiable unit of Data as recognized by the first and second systems, suitable for being individually managed by the systems. For purposes of explanation, this is analogous to the term “data object” as it is commonly used in modern Object-Oriented programming techniques. An Object is a unit of Data that is unique and that can be identified as having an owner, an author, and other defining characteristics. Each Object is uniquely identified, within the Modix where it is located, by an Object ID. Each Object is thus uniquely identified throughout the Global Modix System, by a combination of its Object ID and the ID of the Modix where the Object is located.

### Modix Sharing System

The “Modix Sharing System” is a system for the management of acts of sharing Data Objects from one Operator to another. It operates in the context of a Modix and comprises a specialized set of logic to manage both the delivery of shared Objects, and the rights of all entities with respect to shared Objects.

### Author or Object Author

An “Author” or “Object Author” is an Individual who has created or caused to be created a Data Object, and who thereby has certain special rights to the life-cycle and other management of that Data Object. These rights may be assigned to another Entity by assigning that other Entity as the Object Owner, but the fact of authorship cannot be assigned or transferred.

### Object Sharer or Sharer

An “Object Sharer” or “Sharer” is an Operator who takes action within a Registered App to share an Object. This can be the Object Owner (if an Individual), or the Author if different from the Owner.

### Object Recipient

An “Object Recipient” is an Operator who, by virtue of another Operator sharing an Object to them, receives that Object into a Registered App for which they are the Operator.

### Modix Identification Summary

An Operator who wishes to share Objects with others, or who wishes to be the Recipient of a Shared Object, must register a “Modix Identification Summary,” which is made available to the Sharer and other Recipients if requested and if the Operator agrees to release the information. The Modix Identification Summary need not contain personal information, and may protect the identity of the Operator through use of a pseudonym, but must be the unambiguous handle by which a certain Modix Login is identified to other Users across the System. An Operator, when registering a Modix Identification Summary, must indicate whether the Summary identifies the Operator's real name, and whether contact information is included.

### Further Detailed Description of a First System (Modix)

A Modix is a system comprised of a set of physical or virtual computing components (“Components”), each typically comprised of elements of specialized logic, storage, and connectivity; each Component performs specific tasks, and the Components interconnect in unique and specific ways to achieve the overall system task of managing Mobile App Data, and especially for the purpose of implementing a mobile information exchange. Here we will describe each of these Components, the specific tasks they perform, and how they interact to achieve the intended mobile data management operations.

### Components of a Modix

A Modix is comprised of the following physical, logic, or computing Components operating together:

### TopServer

The “TopServer” is a Server outfitted with a combination of logic, data storage, and connectivity, enabling it to serve as the top hierarchical level of a Modix. It maintains, among other things, a record of all the other Components in the Modix, along with pertinent information for each, and connectivity paths, logins and passwords required to connect with each. In the Modix hierarchy, the TopServer is tasked with controlling all other Servers in the hierarchy.

### AppServers

An AppServer is a Server outfitted with a combination of logic, data storage, and connectivity, enabling it to serve as the interface to a Registered App on a Mobile Device operated by an Operator. Each unique combination of “a Registered App, on a Mobile Device, operated by an Operator” is associated during the App's registration process with a specific Modix, and with a specific AppServer that is a component of that Modix. An AppServer can serve Registered Apps of a plurality of App Titles on a plurality of Devices.

### Intermediate and Management Servers

Depending on the volume of data or traffic, or the complexity of the data management requirements, a Modix may benefit from a more complex structure. Intermediate Servers may be introduced to the Modix topology to provide increased levels of control and sophistication, by creating a hierarchical structure. This allows for a larger or more far-flung Modix, still under the control of a single TopServer. When this is the case, an Intermediate Server is configured to control either: 1) one or more AppServers, 2) one or more Intermediate Servers, or 3) some combination of both of these.

Management Servers are Servers that are specially designed to manage some aspect of the overall task. Examples include but are not limited to: Servers to manage traffic or load balancing, Servers for managerial oversight and authorization of Data Sharing, and Servers to consolidate storage of Data Objects held in common by multiple Operators.

### Modix-Enabled App Titles

An App Developer creates Modix-Enabled App Titles by linking in certain required elements with their own code, and adhering to certain specified practices during the development effort. When ready for release, the Developer submits the App Title to the Modix System Authority for review and certification. Upon certification, the App Title is ready for distribution, and fully prepared to take advantages of the added power of being a Modix-Enabled App.

### Registered Apps

A Modix-Enabled App Title becomes a Registered App, and a component of a Modix, when it is installed on a Mobile Device and registered with that Modix. A plurality of Registered Apps is present in any non-trivial Modix. Every Modix-Enabled App Title has the ability, with certain user input, to register with a Modix. Every Registered App has the ability to communicate with its Modix, and especially with its assigned AppServer.

A Modix is thus made up of hardware and software components of:
One TopServer
Optionally, a plurality of Intermediate Servers
A plurality of AppServers
A plurality of Registered Apps

### Managed Data

The body of data managed by a Modix is comprised of several types, as described below. The operations of the system are carried out according to a set of logic regarding the authorship and ownership of information, and the rights of various users with respect to specific Datasets and Data Objects. This information can be described in the following ways: as Datasets, as Data Objects, and as supporting data for Datasets or Data Objects.

### Data Objects

The data that is managed with respect to Data Objects includes but is not limited to: 1) the specific Data Objects generated or shared to a Registered App, 2) supporting data for each Data Object, describing usage parameters such as who it has been shared to, who is the author, who the owner, and when created.

### Datasets

Once an App has been registered it becomes an active component in the Global Modix System and the System begins to manage its Data. The action of operating a Registered App sometimes generates Data, and all of the Data so generated is termed a Dataset. The Data in a Dataset may be generated by the Operator by means including, but not limited to: typing, by obtaining information from web-based sources, or by receiving Data from another Operator operating a Registered App on another Device.

Typically, a Dataset is stored locally in the permanent storage on the Device as well as being fully represented on the Managing Modix. It is also possible, however, that some Data is referenced in the locally stored Dataset, but is not stored there. Examples of this include large blocks of data such as video, or Data that is only infrequently needed. It is also possible that these types of locally-referenced data are only referenced, not stored, on the Managing Modix, but this is a case that introduces special circumstances with regard to the capability of the System to fully restore this Data.

(Other management functions provided by the system include, but are not limited to: data security and recovery assistance in certain scenarios such as lost or stolen devices.)

During the registration process, an App supplies to the System: 1) a unique App Identifier, 2) a unique Identifier of the Developer, 3) a unique Identifier for the Device, 4) a Modix Login representing the Individual who will use the App on that Device (“Operator”), and optionally 5) a Modix Identifier representing the Modix which will manage the Data therein (“Managing Modix”). Parameters 1, 2 and 3 are provided by the App, while parameters 4 and 5 are provided by the User/installer. If parameter 5 is omitted, or if the Public Modix is directly requested, the Public Modix is assigned as the Managing Modix.

A Dataset is identified as belonging to a combination of the App Title, the Device, the Operator and the Managing Modix. In the Global Modix System, only a single installation of an App Title is permitted on a Device, and only a single Operator is allowed for that App on that Device. The term “Registered App” encompasses: an App, running on a specific Device, used by a specific Operator identified by their Modix Login, and managed by a specific Modix.

A Dataset is associated with a Registered App, representing all of the Data required for the full operations of that Registered App. But a Dataset is not unique to that Registered App. Registering the App identifies the App Title, the Operator, and the Modix. The installer enters an Operator's Modix Login, and either enters a Managing Modix or by default accepts the Public Modix. The App adds its own App Title to the data sent when requesting registration. The Device the Registered App is installed upon is not a factor in the uniqueness of a Dataset. The Dataset is unique by virtue of the combination of App Title, Operator, and Managing Modix.

It is an essential factor in the design of the Modix that the Device is not one of the elements that define uniqueness for a Dataset. For example, say an Operator of a Registered App on a Device loses that original Device and buys a replacement Device. If the same App Title is installed on the replacement Device, and registered giving the same Modix Login and Managing Modix, then the Managing Modix can restore the Dataset from the Registered App on the original Device into the Registered App on the replacement Device. The App on the replacement Device would then contain everything that the App on the original Device contained, and would behave identically. Thus a full restore has been accomplished to the replacement Device.

The organization of the data in the system by identifying it with a Modix and a Modix Login, two elements of this system that are not present in any other system, is one of the unique features of the presently described concepts. It is a feature that provides the system with the means to offer powerful features to users of the system

The combination of an App Title and an Operator is unique within a given Modix

Thus, if an Individual uses multiple Devices, and has installed the same App Title on each of them, registering each App using the same Modix and Login, then although the Registered Apps are different due to being on different Devices, the App, the Operator and the Managing Modix are all the same. In this case, they will be candidates for the Data Sync feature, and if that feature is chosen the Dataset will be identical across these Devices.

Each Device is, however, a uniquely identifiable component of the System, and this uniqueness is utilized in accomplishing the Sync feature. Using Data Sync, each Device operates in cooperation with the Managing Modix to keep itself updated with changes made on other Registered Apps with the same Dataset.

Finally, note that the Device can be removed from the picture and denied access to the Dataset, even though the Dataset was created by a Registered App running on it, such as for example when the Dataset owned by a company is reassigned to a different employee who is using a different device.

### Structure and Behavior of a Modix

A Modix has a consistent basic structure, subject to variation according to specific requirements and/or specialization. A Modix is a collection of Servers organized to accomplish the data management goals of the system, which configuration may change depending on the amount of data, the amount of traffic, and other considerations. A Modix always has a top-level TopServer, and a plurality of AppServers. A plurality of Intermediate Servers may also be present, but are not required. A Modix is thus organized as a TopServer and all of its subordinate Servers. The simplest possible Modix consists of one TopServer and one AppServer, and these logical elements may be combined on one physical Server.

### Data Security Issues

One key benefit of the current art is that it provides a unique ability to maintain data security for the users of the System. The System provides this security in several ways, including but not limited to the following:

Data Security with Respect to the App Developer

An App Developer has an opportunity to build in special logic that would give him or her a means of accessing the Data within the App, once installed and run, without the knowledge or consent of the Operator. The Global Modix System Authority offers a solution to this in the form of examination and verification of offered Apps, as discussed later.

Another possible security breach would be that, without the Global Modix System, the Developer would be required to establish servers needed to accomplish data communications as needed by the App. This means that the security of a User's data will be dependent entirely on the safeguards every App Developer has built into their own server framework.

In contrast, the Global Modix System provides that data communications mechanism in two forms, the Modix Sharing System and the Modix Publishing System. These, combined with the backup and sync features also provided by the Global Modix System, make it possible to build powerful apps that involve data communication, without the need for the Developer to develop any communication logic of their own, and without the need to offer their customers a server to facilitate this logic. In fact, an App that sends data out by some other means than that provided by the Global Modix System should be considered a security risk.

### Data Security With Respect to the Outside World

The design of the System as closed to any communication from outside the Modix System creates an especially secure environment. Only validly registered components of the Global Modix System are allowed to communicate with any other components.

### Data Security With Respect to Other Members of the System

The System is designed such that other users of the System have no access to any Data that is not either shared or published. Data that is sent to others can be sent only through the carefully managed subsystems of the Modix Sharing System or the Modix Publishing System. Each of these has special provisions and mechanisms to control the security of the sent Data, as well as the rights of senders and receivers, as specified in each of those sections.

### Data Sharing and Publishing

Data Sharing and Publishing are features inherent to the design of the Global Modix System, in that the requirement for robust Sharing and Publishing systems, built upon and included in the System, has driven the unique system design of the presently described concepts.

In one embodiment, the description of how Sharing and Publishing are managed must begin with a clear description of what is being Shared or Published. This is where the concept of a Data Object, or Object, becomes useful. This term was defined earlier. Now it is time to describe it in detail and to explain how it interacts with the concept of a Dataset, which has already been used in several descriptions.

A Data Object is a collection of data that is logically grouped. One may think of a single sentence to be sent to a friend or co-worker, or of a complex document made up of many elements, and containing many Objects within it.

A Data Object is also a unit of information suitable for individual management within the System. Objects might be individually deleted, for example. Being suitable for individual management, an Object is the subject of Sharing and Publishing operations: Objects are shared or published, not whole Datasets.

An Object is uniquely identified throughout the System by a combination of an Object ID that is unique within the Modix where it resides, and the unique ID for that Modix. An Object is also associated with an Object Author, and an Object Owner. Object Ownership can be transferred, Authorship cannot. The Author is the person represented by the Modix Login entered during registration of the Registered App where the Object is created. By default and unless changed, the Object Owner is the Dataset Owner associated with the Registered App where the Object is created. When the Object Author and Object Owner are not the same, the Object Owner is the Entity who exercises most of the control over the Object. The Author does retain certain rights, especially control over whether the Object can be edited, and by whom, unless these are specifically assigned to the Object Owner or to someone else.

### The Modix Sharing System

One useful and compelling feature of a Modix is the Modix Sharing System (“MSS”), by which Operators of Apps on Mobile Devices can exchange information. This includes, but is not limited to: sending data, getting feedback and input from recipients, collaboration on projects, and generally point-to-point or multipoint communication of all kinds. App Developers control what Objects in an App can be shared. That is, in order for an Object to be shared, the App must have been designed such that access to the Sharing User Interface elements is provided with respect to that Object. Thus, the design of the App determines which types of Objects are Shareable. In some Apps, the entire Dataset is Shareable.

The MSS utilizes data management mechanisms inherent to the Modix. It begins with the replication of the App Data to an AppServer as described above. Then, if sharing is intended, further communication between Servers (App Servers, Management Servers, TopServers) is initiated, culminating in a communication to the specific AppServer for an App on a Device of each intended Recipient. Having reached this point, the data is finally communicated from that App Server to the Recipient's App on their Device.

### Data Object Ownership and the MSS

The necessity for Data Sharing in a data management system for mobile devices creates the necessity of determining the rights of the parties involved, with respect to that data. The involved parties include the Owner, the Author if different from the Owner, the Recipient, and the Dataset Owner of the Recipient's App's Dataset.

An Object Owner exercises control over important aspects of the management of that Object, but not absolute control. For example, if an Object Owner shares that Object with someone else (a “Recipient”), that Object becomes a part of the Recipient's Dataset. When that occurs, a precise and complex set of Rules comes into play, to determine who can do what with that Object. The Object Owner cannot, for example, decide to delete that Object and thereby cause the copy of it that resides in the Recipient's Dataset to be deleted as well, unless that has been established as the applicable rule. This example illustrates the need for a clear exposition of the Rules of Sharing, which guide the actions of the Modix Sharing System, and the Rules of Publishing, which guide the actions of the Modix Publishing System.

### The Logic of Sharing

Specialized logic residing within various Modix Components implements the Modix Sharing System (MSS). Components involved include the App, the Modix AppServer, and other Servers as well. This logic drives the movement of Data in the Global Modix System according to a set of Provisions.

These Provisions are applicable in the context of 1) usage of Registered Apps that are enabled to allow access to the MSS, 2) management of these Registered Apps by Modixes that allow access to the MSS, and 3) Data Objects designed and intended to be Shared Objects.

### Data Sharing Provision 1: Right to Share

1.1 An Object Owner has the right to share Data Objects it owns.

1.2 An Object Author who is not also the Object Owner has the right to share Objects it has authored, so long as the Object Owner grants permission or has established a sharing permission state that permits sharing of the Object to the intended Recipient.

1.3 An Object Recipient has the right to further share Data Objects that were shared with it, if the Object Owner established this as a parameter for the Share at a level that includes the intended Recipient, and if the Dataset Owner authorizes, tacitly or actively, the further share.

### Data Sharing Provision 2: Right to Delete Shared Objects

2.1 An Object Owner may elect at any time to delete a Shared Object, in the same manner as if the Object had not been shared. The Shared Object may be protected by backups of the Owner's Dataset, or it may be unprotected, thus making the deletion permanent and irreversible. Whether backed up or permanently deleted, a deleted Object cannot be further shared with others because it has no representation in the Sharer's current Dataset. On restoration from a backup, the Owner may again share the Object with more Recipients.

2.2 An Object Author, with the permission of the Object Owner, may delete a shared Object in the same manner as the Object Owner, with the same constraints as in 2.1 above.

2.3 If a Sharer shares a Data Object with a Recipient, and the Recipient accepts that Data Object, the Recipient is granted the right to that Data Object at least for the Recipient's own access, even if the Object is subsequently deleted by the Object Owner. This right of access applies for:

2.3.1 the original Mobile Device on which the Recipient received the Data Object,

2.3.2 a replacement Device,

2.3.3 additional Devices configured to Sync with the original or replacement Device,

2.3.4 Any of the above Devices when executing a data recovery process of the Object, an Object that included the Object, or a version of the Dataset that included the Object.

Provision 2.3.4 describes a situation where the Recipient may have deleted the Object in question, but has functions enabled for the Registered App in question that provide for data recovery to a version of that Registered App's Dataset as it existed at an earlier point in time. Provision 2.3.4 also covers cases where the Recipient may have deleted the Object by virtue of its being included in a containing Object that was deleted, or of being included in a containing Dataset that was deleted, so long as the data backup feature that was in place at the time of deletion included the option to go back to earlier versions, either By Object or By Dataset.

2.4 Data Ownership Provision 2.3 is subject to modification as follows: deletion of the Shared Object by the Object Owner does delete the Object permanently from the Recipient's Dataset, including any and all backups of said Dataset, if, when the Data Object was shared with the Recipient or at any later time, the Recipient indicated consent that the Object Owner may delete copies of the Object from the Recipient's Dataset.

### Data Sharing Provision 3: Right to Identify Sharer

3.1 Unless the right is waived, the Author, Owner, and Recipients (the “parties”) have the right to at least the Modix Identification Summary for the Individual who initiated the Share of the Object. This includes the right to review this information at any later time.

### Data Sharing Provision 4: Right to Identify Share Recipients

4.1 Unless the right is waived, the parties have the right to at least the Modix Identification Summary for all Recipients of the Object. This includes the right to review this information at any later time.

### Data Sharing Provision 5: Right to Identify the Author of a Shared Object

5.1 Unless the right is waived, the parties have the right to at least the Modix Identification Summary of the Author of the Shared Object. This includes the right to review this information at any later time.

### Data Sharing Provision 6: Right to Refuse a Shared Object

6.1 Unless the right is waived, the Recipient has the right to refuse the Shared Object.

6.2 Unless the right is waived, the Recipient's Dataset Owner has the right to refuse the Shared Object. The means of refusing or accepting a Shared Object includes, but is not limited to: a set of permissions that have been put in place; directly replying to a request for authorization to accept a Share Offer; or any other means.

### Data Sharing Provision 7: Usage Permissions for a Shared Object

7.1 The Sharer may establish the Usage Permissions for Recipients of a Shared Object, including but not limited to the ability to: edit, attach Objects to, Share with others, attach reply information, include in a containing Object. The Recipient has the right to view the set of Usage Permissions for the Object, prior to accepting the Object, and any time after accepting it.

### Data Sharing Provision 8: Right not to be Bothered

8.1 The intended Recipient, or the Recipient's Managing Modix, may have established Sharing Permissions that limit the Sharers that may present a Share Offer to the Recipient. For example, an Individual may set up her Personal Modix to disallow Share Offers from a specific list of Senders. In this way, these offers are blocked at the Modix level, and never make an appearance on the Individual's Device in the form of a Push Notification or any other notification

8.2 Individuals may establish filters such as that would automatically decline Share Offers for a specified reason, including but not limited to: the subject being discussed by a group is not interesting to the Individual, or the group is not interesting to the Individual.

### The Sharing Procedure

Sharing a Data Object is a process that involves several steps. These are designed to protect the privacy and security of all parties involved.

Here is the Process in a fairly simple case:

1. An Operator, in their Registered App containing a Data Object, selects the Object to share.

2. Still in their Registered App, the Operator identifies an Individual or Individuals as Recipients.

3. Still in their Registered App, the Operator chooses a collection of “Share Parameters” or Usage Permissions related to the rights of the Sharer and of the Recipients, and optionally generates supporting information such as why they are sharing the Object, or a description of it.

4. Still in their Registered App, the Operator initiates a “Share Request,” which is sent to the Managing Modix for this Registered App. This includes the Object, intended Recipients, Parameters and supporting information.

5. The System processes the Share Request and sends a Share Offer to the Managing Modix(es) of all Suitable Recipient Registered App (SRRA) for each Intended Recipient.

6. Each Managing Modix that receives the Share Offer generates a Share Offer that is sent to the SRRA of the intended Recipients. The Share Offer contains 1) identification of the Sharer, 2) terms of the Share as per the Share Parameters, 3) if provided by the Sharer, a description and/or summary of the Object, and 4) if provided by the Sharer, a note describing why the Sharer is sharing the Object.

7. Intended Recipients may, via their SRRA, view all of the information provided in step 3. They may accept or decline the Share Offer.

8. For the intended Recipients who accept the Share Offer, their SRRA is sent a copy of the Shared Object, which is presented to them in accordance with the manner in which that App Title presents Objects of that kind, along with supporting information about the Sharer, the date and time it was shared, the date and time it arrived, and other information, such as other Individuals it was shared with.

9. The SRRA having received a copy of the Shared Object, this Object is now a part of the SRRA's Dataset.

10. The Registered App from which the Sharer shared the Object receives and displays information about who has accepted the Shared Object.

When an app-user (in this example, called the sender) has an App on her Mobile Device that is registered with one Modix (either Enterprise, Personal or Public) and wants to share Data with another app-user (the receiver), it is possible that the receiver's App is registered with a different Modix, and thus communicates directly with an AppServer not the same as that used by the sender. This situation is represented in FIG. 10.

Here is the Process if the Sharer's Managing Modix, and a Recipient's Managing Modix, are equipped with defined Share Permissions and with share authorization features enabled:

Steps 1-4 are the same as above

5. The Sharer's Managing Modix evaluates the Share Request for each Intended Recipient. If the Managing Modix has been equipped with a standing set of Share Permissions, these are checked against the Share Request. For each Intended Recipient, if the Share Permissions are sufficient and relevant such that permission can be granted, the Managing Modix sends a Share Offer to the Managing Modix of the intended Recipient.

6. If the standing Share Permissions on the Sharer's Managing Modix are not sufficient to allow the Share, the Managing Modix generates a notice to the Dataset Owner, that a request has been made which requires a manual approval. The designated Share Authorization Officer (SAO) for the Dataset Owner may approve or deny the Share Request.

7. If the designated SAO approves the Share, it goes ahead. If not, it goes back to the Sharer for further negotiation.

8. If a Recipient's Managing Modix has standing Share Permissions in place, these are checked against the name, company, title, etc. for the Share, to determine whether the Share Offer can be allowed to be presented to the Intended Recipient.

9. If no standing Share Permissions are in place to definitively allow or deny the Share, and an authorization officer exists, a request is sent to the authorization officer for approval of the Share.

10. If, by either step 8 or 9, the Share is approved to enter the Managing Modix of the Intended Recipient, then the Share process continues as per steps 6-9 in the above example.

### Efficiency

A principle feature of the presently described concepts is the efficiency with which all of the described features are provided. This can refer to: 1) the speed with which data is accessed due to an efficient design, and 2) a cost-efficient means of storing data. At all times, efficiency must be measured in the context of providing the full set of features described in the presently described concepts, which is not a feature set to be found in any prior art.

### Data Storage Efficiency

The long-term storage of data has a cost. One measure of efficiency when looking at the entire system is: how many times does the same data need to be stored? One can imagine that the system described so far might suffer from a great degree of data redundancy. The current art includes several unique mechanisms for reducing duplicated data, on a specific Device, within a Modix, and across the Global Modix System as a whole.

### Data Storage Efficiency on a Device

Each Registered App on a Device has a place reserved for its data on the Device's permanent storage. As each Object in a Registered App is uniquely identified, there is only need to maintain one copy of that Object in the Device's local storage. Local storage of Objects is valuable because it means the Operator can access that information almost immediately. If that data were stored only on the Modix, the Operator would have to wait for it to be downloaded anew each time the App was run. But some Objects are large, or infrequently needed, or a combination of these two. This results in a case where the delay in retrieving the Object from the Modix, or the lack of availability of the Object when there is no network, is an acceptable solution, when compared against the amount of local storage space it would take up. The solution provided by the Global Modix System is that the Operator can be granted access to a set of user-interface elements by which she can indicate that specific Objects should only be referenced locally, and when access is needed, the Object must be downloaded from the Managing Modix. This is called “Save As Reference.”

The App Developer may make this feature available for any Object that can be individually managed by the Operator. Typically, Objects that might become large are considered for this. In addition, Objects retrieved by the App via the Sharing System or the Publishing System, are by default available for setting to “Save As Reference.”

Data Storage Efficiency within a Modix

As stated earlier, the logic that resides on the Servers that make up a Modix is logic that is provided by the Global Modix System Authority. This logic contains special algorithms that reduce redundancy by only storing an Object on one AppServer: by default this is the AppServer that is the direct manager of the App where the Object was generated. This location may be changed, however, by the internal logic, based on traffic efficiency considerations.

In addition, logic is included that monitors the number of times large Objects are accessed, and by which AppServers or other connections, and which places the Object on a Server that minimizes the number of servers between the storage location and the most frequent accessing destinations.

The Dataset for each Registered App is stored within permanent storage local to the Mobile Device. Each Dataset therein is only accessible by the App it belongs to. This concept is sometimes called “Sandboxing” and is a common constraint of Mobile Device operating systems. Sandboxing provides data security by not allowing one App to access the data of another App on the same device. Sandboxing is not a part of the presently described concepts; rather, it is a standard in industry that the presently described concepts are designed to accommodate. Here, we are illustrating that a Dataset is designed to exist within that common constraint: while sandboxed in local permanent storage on the device, it is also represented as a collection of objects plus metadata in permanent storage on the Modix system servers, although not necessarily as a cohesive whole. The individual objects that make up the Dataset may be stored on the App's AppServer, or the AppServer of a sharer or collaborator. These objects may also be stored external to the user's selected Modix in certain cases.

### Method Supporting Modix Development

Some ancillary services are required for the creation of a functioning Modix. These include Developer Tools, and a Development Modix for testing. The tools offered to App Developers make it possible to create and distribute App Titles that behave properly as Modix-Enabled Apps, but these tools are not directly a part of the live and functioning Global Modix System. Likewise, the Development Modix performs a needed service for Developers, but only as a temporary, parallel Modix for testing. It does not connect with an actual “live” Modix.

### Developer Tools for Creation of Modix-Enabled Apps

The Global Modix System Authority provides to App Developers a set of “Developer Tools” in the form of linkable code libraries, includable files, documentation, examples, tools, and other support. Developers utilize these to create App Titles which, once registered, operate as components of the Global Modix System. A properly developed App Title is termed “Modix-Enabled.” An App is Modix-Enabled if a) it has been linked with a ModixLib and other needed files that are provided in the Modix Development Package, b) it has been developed using certain requisite design patterns and Classes, and c) a set of configuration data is included, including the ID of the App Developer.

All Data in the Global Modix System is organized as Data Objects, or Objects. The Developer Tools provide abstract classes that contain within them the logic needed to be accepted as Data Objects by the Global Modix System. This means, in practice, that the Developer only needs to define any needed Data Object as a subclass of one of the data classes supplied in the Developer Tools. Instances of that object are automatically accepted as Data Objects in the System.

App Developers may elect to use the data management features of an embedded Modix library, but not to enable Modix System Services. This means that the App will behave as a standalone app, not sending Data to any other Global Modix System component. Data backup, sync, and sharing do not function in this situation. In some cases, the App Developer may elect to let the User decide whether Modix System Services should be enabled for an App, after it is installed.

A Developer does not create logic to handle the registration of an App. This operation is accomplished by a combination of 1) logic that resides in a software library that must be linked into an App Title, which presents, usually within the operations of the App, user-interface elements needed to guide the installer/user through the registration process, in combination with 2) logic that resides on various other components of the Global Modix System. As a result, the Developer does not have any control over whether a Registered App used the Public Modix, or a Private Modix, or which Private Modix the installer might select.

### Development Modix System for Testing of Modix-Enabled Apps

As part of the supplied Developer Tools, a “Development Modix System” is supported by the Global Modix System Authority, and provided to be used by App Developers during their development efforts. The Development Modix System is almost identical to an actual Modix, but is completely isolated from the Global Modix System. This provides Developers with controls that are sometimes needed during development. As an example, if the Developer realizes the need for a re-definition of a Data Object, it is possible to clear out all the Data associated with their development project so far, and start fresh with an empty Dataset.

Once a Developer decides that an App Title is ready to be released, it is submitted to the Global Modix System Authority, which examines it on several criteria to determine its fitness to join the Global Modix System. Once it has been approved and activated by the Global Modix System Authority, from that point all newly installed and registered Apps no longer access the Development Modix System; they access the real, active, connected Global Modix System instead. For Apps that are registered with the real Global Modix System, Developers no longer have control or access to any Data generated by those Apps. Control belongs instead to the Global Modix System and to the Entities therein, as determined by the Rules of Data Ownership and Access.

### App Testing and Verification for Security

App Developers who wish to sell their Apps into markets where data security is paramount, such as Enterprise markets, may request that the Global Modix System Authority examine and verify their App as not containing any logic to send data, or to respond to other devices requesting data, besides those means provided by the Global Modix System. This examination includes but is not limited to: sending data via WiFi, via Bluetooth, via a physical connection, or over the cellular network.

Apps that can be marketed as having passed the scrutiny of the Global Modix System Authority, and thus verified to include no ability to send data, outside of the controlled services provided by the System, have a special attractiveness when marketed to Enterprises.

### Further Detailed Description of a Second System (Global Modix System)

In describing any data management system, it is useful to include in the narrative the people who interact with the system, to illustrate how these interactions might take place, and how these people obtain benefit from the system. The Global Modix System does keep a record of Individuals and Entities as defined above, and while these are the prime movers in a way, they are not, strictly speaking, elements or components of the System. The Global Modix System is comprised of a set of physical or virtual computing Components, each of which contributes to the execution of a specific portion of the overall system task, namely the Management Operations for mobile data that is under the control of the System. These Management Operations are carried out according to a set of Rules regarding the rights and ownership of data. A full description of the System must describe all of these elements and how they interact. Sections below will describe in detail each of these: the Components, the Mobile Data Management Operations (how data moves through the System, and where it is stored), and a set of Rules for Data Ownership and Rights that inform these operations.

### Components of the Global Modix System

A fully operational Global Modix System is comprised of the following physical, logic, or computing components operating together:

### Hardware Components

Components listed here are identified as hardware components by convention. Each of these components contains specialized logic (or software), and it is this specialized software that enables them to function in their appointed roles. Each component typically also contains dedicated long term storage, and optionally a relational database management system (RDBMS) and specific database structures. Further, these components may be virtual, in that several of them may share a single hardware platform. However, ultimately, there must be hardware reserved for these functions, and it is standard policy within the industry to speak of these services as hardware-based.

### ModixCentral

One and only one ModixCentral exists in the Global Modix System, as the unambiguous top hierarchical level to the System. It is a server that contains specialized logic to identify and communicate with the various Modixes, and with the Registered Apps on Devices that make up the rest of the System, and to facilitate connections between these components as required.

### Modixes

A Modix is one of the components of the Global Modix System, and the Global Modix System contains a plurality of Modixes. Each Modix performs as a single cohesive unit with respect to other components. Each Modix in turn, however, may contain several components within it for specialized tasks, as enumerated here:

A plurality of Modixes is present in the Global Modix System, including a Public Modix and a plurality of Private Modixes. Each Modix, on being brought into service, is registered with ModixCentral. Each Modix communicates with ModixCentral and with other Modixes as required. Each Modix also communicates with and exchanges Data with Registered Apps for which it is the Managing Modix.

The “TopServer” is a Server that is the top hierarchical level of a Modix. It handles publishing the Modix's existence to ModixCentral, and all communication with ModixCentral. All initial requests from ModixCentral or from other Modixes directed to a specific Modix go initially to that Modix's TopServer.

### Mobile Devices

A Mobile Device is a component of the Global Modix System if it has a Registered App installed on it. A plurality of Mobile Devices is present in the Global Modix System.

The Global Modix System is thus made up of hardware and software components of:

One ModixCentral

A plurality of Public Modixes registered with ModixCentral

A plurality of Private Modixes, registered with ModixCentral

A plurality of Modix-Enabled App Titles, registered with ModixCentral

A plurality of Registered Apps, registered with ModixCentral

A plurality of Mobile Devices, registered with ModixCentral, on which are installed a plurality of Registered Apps

### Private Modixes and the Public Modix

An Entity may register a Modix with the System that is a Private Modix, and that is intended to manage only the Data related to the Registered Apps utilized by or on behalf of the Entity. A Private Modix can be of several different types, depending on the requirements of the Entity.

Anyone who wishes to make use of the basic features of the Global Modix System, but who does not wish to establish a Private Modix, may use the Public Modix. The Public Modix provides the fundamental features of the Global Modix System: access to backup/restore/sync and data sharing/publishing operations. Some other features are only available through a Private Modix.

From the perspective of other components of the Global Modix System, all Modixes, including the Public Modix and all variations of a basic Modix, behave alike in that they respond to a specified set of communications from ModixCentral, from other Modixes, and from their Registered Apps with responses that are well defined and delineated. Additionally, they can initiate communications with ModixCentral, other Modixes, and their Registered Apps only in well-defined and delineated ways.

### Designed for Efficiency

One key purpose of the structure of the Global Modix System is to make the bulk of the communications as efficient as possible. Thus, although an App may communicate directly with ModixCentral for its original registration, the channel of communication is resolved during registration to enable the Registered App to communicate directly with a specific assigned AppServer, a component of a specific Modix. The assignment of a Modix (with the installer's input) resolves ownership issues related to the Data, and the assignment (by that Modix) of a dedicated AppServer creates an optimal network with respect to efficient movement of Data. This remains the line of communication during normal operation: a simple and direct connection between the Registered App and a dedicated AppServer.

### Management of the Public Modix

The Global Modix System Authority maintains the Public Modix and all the Data managed thereby. The Global Modix System Authority is solely responsible for managing load balancing, security and other matters related to the Public Modix. Individuals who take advantage of the Public Modix maintain their rights to the Data organized in the Datasets of their Registered Apps, as per the Rules, and maintain their rights to privacy, data security, and recovery. These services are attached to a Modix Login created by the Individual and provided during registration of an App. A Registered App is the largest organizing principle in the Public Modix. That is, there is no organizing principle in the Public Modix equivalent to “everything for a company,” “for a family,” or “for a person”. These types of data groupings are the domain of Private Modixes. Users of the Public Modix do not have access to certain other management controls sometimes provided by a Private Modix.

### An Exemplary Global Modix System

The Global Modix System is constantly growing and changing as businesses and Individuals come and go, and this causes the System organization to also change. However, an exemplary snapshot of one possible organization can be seen in FIG. 1, and this can be used to describe several typical configurations. Later, in the Exemplary Uses section, FIG. 1 will also be used to illustrate exemplary descriptions of some common real-life situations, and the value the Global Modix System offers in these situations.

### Disconnected Private Modix

An Entity that is concerned about data security above all things may elect to establish a Privately Managed Private Modix that is not registered with ModixCentral, and thus does not interact with ModixCentral or with other Modixes.

In establishing a Disconnected Private Modix, the Entity does sacrifice, for all Registered Apps managed by it:

1. Sharing Data with others or publishing to others outside of the galaxy of its Private Modix.

2. Having any Data shared with its members from outside, or allowing its members access to any Published Works from outside the Disconnected Private Modix.

### Disconnected Private Modix Network

An Entity that maintains one or more Disconnected Private Modixes may elect to establish connections between them, to allow Data Sharing or publishing between these Modixes, but still without risking connection to ModixCentral or any of the other Modixes connected to it. In order to be Modixes, and to respond properly to Modix-Enabled Apps and to other Modixes in the Disconnected Network, it is still required that these Modixes by certified by the Global Modix System Authority. But upon bringing them online, they are not required to register with ModixCentral, and they are not required to respond to any other Modix outside the Disconnected Private Modix Network.

### Data Storage Efficiency Across the System

Say, for example, that an Author publishes a work, and that fifty people, who's Apps are managed by fifty different Modixes, choose to download that work. According to the description of the System to this point, in addition to the Author's copy, fifty more copies must reside on the fifty Modixes that manage a copy of the fifty Datasets on which that Item is replicated. This would be a method that insures that each person who downloaded the Published Item would have access to it later, even if the Publisher had deleted her copy. But it would be an expensive method: each Modix would incur the cost of storing that Item.

The Global Modix System offers a solution to this, which is available to the managers of Private Modixes, and which is built into the logic of the Public Modix. The Public Modix already maintains only a single copy of any Item defined within its purview. In order to insure that the Item is not deleted unless every App that includes the Item in its Dataset has released the Item, it maintains, along with the Item, a list of the Datasets that require its existence.

Managers of Private Modixes, when encountering an Item that may be already stored on the Public Modix, can request that the Public Modix also hold the Item on their behalf. In an exemplary embodiment, the Public Modix records the Private Modix as another entry in the list of “those who need the item.” The Private Modix can then delete its own copy and access the Public Modix's copy whenever that Item is called for by a Registered App. The Private Modix keeps its own record of the Datasets within its purview that need that Item. When all of these no longer need to keep the Item, the Private Modix can indicate to the Public Modix that the Item no longer needs to be kept on its behalf, and the Public Modix can remove that Private Modix from its maintained list of “Item users.” Only when the list of Item users is empty is the Public Modix allowed to release the Item.

Private Modixes who share a copy of the Item with the Public Modix, and other Private Modixes as well, share in the cost of maintaining that Item. This cost, since it is distributed across multiple Modixes, should always be less than the cost of keeping the Item stored within the Private Modix itself. Managers of the Private Modix are always free to elect to store the Item internal to their own Modix instead. Besides a cost comparison, this may be a desired option to speed up access to their Operators in some cases.

### Exemplary Uses

FIG. 1 can be used to illustrate a variety of common situations and how people might make use of the Global Modix System. Saying for this example that Modix 4 is the Public Modix, this illustrates a configuration that would result if an Individual who owned Device 12 was not affiliated with a Private Modix. This shows two Apps, 16 and 17, installed on Device 12, and both of these Apps communicate directly, during normal usage, with the Public Modix 4. Public Modix 4 contains special logic which drives its behavior as the Public Modix.

Next, with respect to Device 13, this configuration might result in the following exemplary case: a person (call her Jane) owns Device 13, and installs and registers an App 16, without specifying a Private Modix to be used. Registered App 16 therefore has Public Modix 4 as its Managing Modix.

Now, say that Jane is an employee of a company (call it XYZ Corp) that controls a Private Modix 5, of a special type called an Enterprise Modix. Jane utilizes App 18 on Device 13 for business activity for her employer, so when registering App 18, she specified XYZ Corp's Modix 5 as its Managing Modix. In this case, the Dataset for App 18 on Device 13, which contains all of the Data from Jane's use of App 18, is managed by the XYZ Corp's Modix 5.

To demonstrate the usefulness of the Global Modix System for businesses, let's imagine that Jane leaves the company, and XYZ Corp is unable to get access to Device 13, which belongs to Jane. Using management features available on the Enterprise Modix 5, XYZ Corp can prevent Jane from further access to the company Data that was generated on XYZ's behalf by her use of App 18 while employed there. Even though App 18 was installed on her personally owned Device 13, because the employer's Modix 5 is the Managing Modix, the employer can lock App 18 from any future operations on that Device 13. Further, XYZ Corp can assign that Dataset to a different employee on a replacement device (not shown), by installing an App of the same App Title as App 18 to the replacement Device, and loading it with the Dataset that was generated by Jane when she was an employee. Thus the company has preserved a copy of its Data, and maintained control of it.

Still looking at FIG. 1, consider an alternative example: the Device 13 operated by Jane is not her own phone, but was provided by XYZ Corp for her use while employed there. Also, for this example let us say that Modix 4 is a Private Modix of a special type called a Family Modix, managed by Jane for her family. Jane has two Registered Apps 16 and 17 installed on Device 13 (the Device owned by XYZ Corp) that she utilizes for personal use. Despite the Device being owned by XYZ Corp, Jane can register these personal use Apps 16 and 17 with her own Family Modix 4. Doing so means that Modix 4, her Family Modix, not her employer's Modix 5, is the Managing Modix for the personal Apps 16 and 17 on the company's Device 13. Thus she is not using the company Modix resources for personal use, and her personal Data is shielded from XYZ Corp. If the relationship is terminated, Jane can acquire her own replacement Device (not shown), install Apps 16 and 17 on the replacement Device, register them with her Family Modix 4 as she did before when using the company's Device 13, and recover the Datasets for Apps 16 and 17, without the need to access her ex-employer's Modix 5. As shown in the previous example, XYZ Corp is also not at risk of losing Data on termination of this relationship, whether or not the company is able to recover its Device 13. The Dataset which Jane created using App 18 on Device 13 for company use, is safely backed up on XYZ Corp's own Modix 5, and can be kept securely, and reassigned to a different employee if desired.

The above examples, using FIG. 1 to illustrate, demonstrate the separation of several Apps residing on the same Device with respect to the management of their Data by the Global Modix System, and with respect to mixing personal use and business use on a Device. They also show the value to both the employee and the employer when different Apps on the same Device can be configured to have different Modixes as their Managing Modix. Several useful features can be enumerated from the examples given using FIG. 1, which directly result from the design of the Global Modix System:

1. Users don't have to carry two separate Devices: one for work and the other for personal use.

2. Companies gain a greater freedom to utilize mobile devices and mobile Apps in their business practices, because they are securely in control of the company Data residing thereon.

3. Employees gain greater control over personal data residing on a Device that is assigned to them by an employer, including the right to privacy, and the ability to regain that personal Data if they are asked to relinquish the device

4. Companies can securely utilize Apps residing on Devices owned by employees, and employees are free to use a Device of their choosing.

What is claimed is:

1. A mobile device, comprising:
a communication device;
a display;
an input device;
a processor; and
a non-transitory computer readable medium storing an operating system defining a local file system on the non-transitory computer readable medium, the non-transitory computer readable medium storing an app having an app layer, that upon execution by the processor, causes the processor to:
visually depict information prompting a user to identify a data management system configured to manage data for the app;
receive an identification of a data management system via the input device; and
establish communication between the app and an identified data management system via the communication device.

2. The mobile device of claim 1, wherein the operating system is configured to limit a user's access to a local file system to prevent making a personal backup.

3. The mobile device of claim 1, wherein the data management system further comprises an app server and the app layer further causes the processor to interface with the identified data management system to register an application and obtain connection information to establish communication between the app and the app server designated by the identified data management system.

4. The mobile device of claim 1, wherein the data comprises data objects, and wherein the app layer further causes the processor to uniquely identify data objects related to the app stored on the non-transitory computer readable medium.

5. The mobile device of claim 4, wherein the data objects are identified as a complete backup for an application.

6. The mobile device of claim 4, wherein the data objects are identified as a collection of related data objects, related to the app, and as capable of being shared on a per-object basis.

7. The mobile device of claim 4, wherein the app layer further causes the processor to transmit the data objects stored on the non-transitory computer readable medium, relating to the app, to the data management system to synchronize a copy of the data objects located on the data management system with the data objects stored on the non-transitory computer readable medium.

8. The mobile device of claim 7, wherein the app layer synchronizes the copy of the data objects located on the data management system with the data objects stored on the non-transitory computer readable medium upon a change made to the data objects stored on the non-transitory computer readable medium.

9. The mobile device of claim 4, wherein the app layer further causes the processor to receive data objects from the data management system and store the data objects on the non-transitory computer readable medium in a portion of the non-transitory computer readable medium designated for use by the app.

10. The mobile device of claim 1, wherein the app layer further causes the processor to visually depict a plurality of predetermined different data management systems on the display, and permit selection by a user of at least one of the plurality of different data management systems.

11. One or more non-transitory computer readable medium storing an app layer that when integrated into an app, and executed by one or more processor cause the one or more processor to:
visually depict information prompting a user to identify a data management system configured to manage data for the app;
receive an identification of a data management system via an input device;
establish communication between the app and an identified data management system via a communication device;
register the app with the data management system;
identify one or more data objects relating to the app; and
transmit the one or more data objects to the identified data management system.

12. The one or more non-transitory computer readable medium of claim 11, wherein the data management system further comprises one or more app server and the app layer is configured to cause the processor to interface with the identified data management system to register the app and obtain connection information to establish communication between the app and an app server designated by the identified data management system.

13. The one or more non-transitory computer readable medium of claim 12, wherein the app layer is configured to cause the processor to store connection information for the app server designated by the identified data management system in the non-transitory computer readable medium.

14. The one or more non-transitory computer readable medium of claim 11, wherein the one or more data objects are identified as a complete backup for the app.

15. The one or more non-transitory computer readable medium of claim 11, wherein the one or more data objects are identified as a collection of related data objects, relating to the app, and as capable of being shared on a per-object basis.

16. The one or more non-transitory computer readable medium of claim 11, wherein transmitting the one or more data objects to the identified data management system further comprises creating a copy of the data objects located on the identified data management system capable of being synchronized with the one or more data objects stored on the one or more non-transitory computer readable medium.

17. The one or more non-transitory computer readable medium of claim 16, wherein the app layer is configured to synchronize the one or more data object stored on the one or more non-transitory computer readable medium with the one or more data objects stored on the data management system upon a change made to the data objects stored on the non-transitory computer readable medium.

18. The one or more non-transitory computer readable medium of claim 11, wherein the app layer is configured to cause the processor to receive data objects from the data management system and store the data objects on the non-transitory computer readable medium in a portion of the non-transitory computer readable medium designated for use by the app.

19. The one or more non-transitory computer readable medium of claim 11, wherein the app layer further causes the processor to visually depict a plurality of predetermined different data management systems on a display, and permit selection by a user of at least one of the plurality of different data management systems.
